(19) United States
(12) Patent Application Publication
(10) Pub. No.: US 2016/0184180 A1
(43) Pub. Date: Jun. 30, 2016

(54) CARDIOPULMONARY RESUSCITATION SUPPORT DEVICE

(71) Applicant: Sumitomo Riko Company Limited, Aichi (JP)

(72) Inventors: Ichinosuke MAEDA, Aichi (JP); Hiroaki ITO, Aichi (JP); Yota KOKUBO, Aichi (JP); Shingo HIBINO, Aichi (JP); Hiroshi YAMADA, Aichi (JP); Kouichiro MINAMI, Kanagawa (JP)

(73) Assignee: SUMITOMO RIKO COMPANY LIMITED, Aichi (JP)

(21) Appl. No.: 14/943,093

(22) Filed: Nov. 17, 2015

(30) Foreign Application Priority Data
Dec. 26, 2014 (JP) 2014-265110
Jul. 27, 2015 (JP) 2015-147883

(51) Int. Cl. A61H 31/00

(52) U.S. Cl. CPC A61H 31/005; A61H 31/007; A61H 2201/5071

(57) ABSTRACT

A cardiopulmonary resuscitation support device including: a pressure sensing part configured to overlap a chest and including a flexible dielectric layer formed of an elastomer, and a flexible first and second electrodes formed of a conductive elastomer overlapped on two surfaces of the dielectric layer; a detection part provided at a facing part of the two electrodes to detect changes in electrostatic capacity; a power supply device to apply measurement voltage and a detection member to obtain the electrostatic capacity detected by the detection part connected to the electrodes; a processing member to calculate at least one piece of evaluation information among a number of compressions, a number of compressions per unit time, a pressing depth during compression, a pressing depth during release, and a ratio of a compression time, based on a detection value from the detection member.

### INCORPORATED BY REFERENCE

The disclosures of Japanese Patent Application Nos. 2014-265110 filed on Dec. 26, 2014 and 2015-147883 filed on Jul. 27, 2015, each including the specification, drawings and abstract is incorporated herein by reference in its entirety.

### BACKGROUND OF THE INVENTION

1. Field of the Invention

The present invention relates to a cardiopulmonary resuscitation support device that assists so as to perform chest compressions suitably with implementation or training of cardiopulmonary resuscitation using chest compressions.

2. Description of the Related Art

From the past, cardiopulmonary resuscitation (CPR) using compressions to the chest has been known as one form of life support during cardiac arrest. With cardiopulmonary resuscitation, as is generally and broadly known, by a person giving life support intermittently compressing the chest of a person receiving life support who is in cardiac arrest and artificially causing the heart to beat, the blood circulation and thus oxygen supply to the brain and the like attributable to this is maintained, and the heartbeat is prompted to restart.

Meanwhile, with cardiopulmonary resuscitation using chest compressions, it is thought to be important to have suitable levels of chest pressing depth and the number of compressions per unit of time during compression, to have sufficient chest release (recoil) in the intervals between chest compressions, and the ratio of the chest compression time (duty cycle) and the like, and we can expect improved lifesaving rates, good prognoses and the like with proper implementation of cardiopulmonary resuscitation.

However, even at the present time, a device for suitably assisting cardiopulmonary resuscitation by showing the proper chest compression position has still not been provided. In particular, with cardiopulmonary resuscitation, placing a force point on the lower half of the ribs is considered to be effective, but there was no cardiopulmonary resuscitation support device that actually detects that and determines whether or not compression is being done with the force point at a suitable chest compression position, and would guide the force point to a suitable chest compression position.

In U.S. Publication No. US2004/0267325, proposed is a cardiopulmonary resuscitation support device that notifies a person giving life support of the determination results of whether or not the chest compression and release are being performed appropriately, with the goal of having cardiopulmonary resuscitation executed easily. However, with the device noted in US2004/0267325, an accelerometer housing is adhered to the chest of the person receiving life support, and by compressing the chest of the person receiving life support via the accelerometer, changes in the acceleration due to compression and release is detected by the acceleration sensor housed in the accelerometer housing, and this is nothing more than determining whether the chest compression and release is being executed suitably based on the detection results.

In fact, with the cardiopulmonary resuscitation support device of US2004/0267325, a hard accelerometer housing was mounted by adhering onto the chest of the person receiving life support, so it is difficult to mount and hold this in a tightly adhered state to the chest surface of the person receiving life support which is constituted with complex curves with individual variations. Therefore, problems may occur such as variation of the detection accuracy due to wobbling of the accelerometer housing, falling off from being on the chest, and the like. In addition, with chest compressions via the hard accelerometer housing, problems are likely to arise such as pain or injury to the chest of the person receiving life support, to the hand of the person giving life support, or the like.

Also, the person giving life support who received normal cardiopulmonary resuscitation training is not used to doing compressions indirectly on the chest of the person receiving life support via the hard accelerometer housing, so using the cardiopulmonary resuscitation support device noted in US 2004/0267325 would in fact have the risk of making it difficult to do suitable compressions. It is conceivable to use the cardiopulmonary resuscitation support device noted in US2004/0267325 during training, but in that case, conversely, in a case such as of having to perform cardiopulmonary resuscitation in an emergency and not going via the hard accelerometer housing that one is used to with training, it will be necessary to do direct chest compressions which are different from during training, and there is the risk of not being possible to suitably execute cardiopulmonary resuscitation.

### SUMMARY OF THE INVENTION

It is therefore one object of the present invention to provide a cardiopulmonary resuscitation support device of novel structure which is able to maintain a mounted state corresponding to the shape of the chest surface and stabilize the detection accuracy, and also to reduce the sense of unfamiliarity during use.

The above and/or optional objects of this invention may be attained according to at least one of the following modes of the invention. The following modes and/or elements employed in each mode of the invention may be adopted at any possible optional combinations.

A first mode of the present invention provides a cardiopulmonary resuscitation support device for assisting with cardiopulmonary resuscitation using chest compressions, comprising: a pressure sensing part configured to be overlapped on a chest, the pressure sensing part including a flexible dielectric layer formed of an elastomer, and a flexible first electrode and a flexible second electrode formed of a conductive elastomer and overlapped on respective two surfaces of the dielectric layer; at least one detection part provided at a facing part of the first electrode and the second electrode in the pressure sensing part so as to detect changes in electrostatic capacity that accompany changes in a facing distance between the first electrode and the second electrode; a power supply device to apply measurement voltage connected to the first electrode and the second electrode; a detection member to obtain the electrostatic capacity detected by the detection part, the detection member being connected to the first electrode and the second electrode; and a processing member to calculate at least one piece of evaluation information from among a number of chest compressions, a number of chest compressions per unit of time, a chest pressing depth during chest compression, a chest pressing depth during chest release, and a ratio of a compression time of pressing the chest and a return time of not pressing the chest, based on a detection value of the electrostatic capacity detected by the detection part obtained by the detection member.

With this kind of cardiopulmonary resuscitation support device constituted according to the first mode of the present invention, the pressure sensing part overlapped on the chest of the person receiving life support is constituted with a capacitance type sensor having a flexible structure, and for example can be a flexibly layered sheet form overall, and can easily deform along the chest surface shape. Therefore, it is easy to tightly adhere the pressure sensing part to the chest, and possible to easily position and hold the pressure sensing part on the chest, so a decrease in detection accuracy or the like due to a gap occurring between the pressure sensing part and the chest does not occur easily, and it is possible to do stable detection of chest compressions.

In particular, with the present invention, by using the capacitance type sensor, compared to items that use a conventional acceleration sensor or the like, regardless of the environmental conditions, it is possible to obtain stable measurement accuracy. Specifically, when detecting the chest compression state with an acceleration sensor, it is difficult to avoid the effect due to the elasticity of the back matting on which the person receiving life support is placed, and the measurement value differs between a person receiving life support on a flexible bed and a person receiving life support on a hard bed. However, with the cardiopulmonary resuscitation support device of the present invention, regardless of that kind of environmental condition, it is possible to acquire various measurement values along with chest compressions, with stable precision. Also, when used for a person receiving life support being transported by stretcher, ambulance, helicopter or the like, or for a training dummy model, with the acceleration sensor, the vibration during transport affects the detection results, so it is difficult to give proper support for cardiopulmonary resuscitation. On the other hand, if a capacitance type sensor that detects changes in electrostatic capacity that accompany changes in the facing distance between electrodes is used, the effect of vibration during transport is avoided, and it is possible to correctly detect chest compressions.

Also, by using the capacitance type sensor, it is also possible to give guidance for the compressed state of the chest by the person giving life support to be more suitable, which was not realized with items using a conventional acceleration sensor or the like. Specifically, with the capacitance type sensor, it is also possible to detect the pressed state of a plurality of points set in a region that expands with a designated surface area. Thus, for example it is also possible to detect the compression position as noted in the fourth mode described later, and by displaying pressure force and position information on a monitor or the like so as to have the person giving life support be aware of that, it is possible to easily realize directing of the person giving life support to be able to achieve more suitable pressure force, positioning and the like.

Furthermore, since the pressure sensing part of the cardiopulmonary resuscitation support device is able to deform flexibly, when the person giving life support implements cardiopulmonary resuscitation by compressing the chest of the person receiving life support (close chest heart massage), the sense of unfamiliarity with performing chest compressions via the pressure sensing part is reduced. Therefore, for example, even when implementing cardiopulmonary resuscitation without the cardiopulmonary resuscitation support device after doing training using the cardiopulmonary resuscitation support device of the present invention, by compressing the chest of the person receiving life support the same way as during training, it is possible to suitably execute cardiopulmonary resuscitation. In fact, since it is possible to avoid the occurrence of pain or injury due to compression via the cardiopulmonary resuscitation support device with the hand of the person giving life support or the chest of the person receiving life support, it is possible to also handle long term heart massage, for example.

Also, based on the detection values of the capacitance type sensor (pressure sensing part) equipped with the detection parts, by calculating at least one item among the number of chest compressions, the number of chest compressions per unit of time, the chest pressing depth during chest compression, the chest pressing depth during chest release, and the ratio of the chest compression time, which are important parameters with cardiopulmonary resuscitation, it is possible to evaluate the executed cardiopulmonary resuscitation.

Furthermore, with the cardiopulmonary resuscitation support device of this mode, it is also possible to provide a storage means that stores over time the detection values of the capacitance type sensor (pressure sensing part), the measurement values that underwent calculation processing by the processing member, and the like. By providing this kind of storage means, for example, based on information within a specified time such as the current point in time from measurement start or the like, it is possible to also find the implementation time of chest compressions implemented on the person receiving life support, the time for which that impletion was suspended and the like, and to output that externally.

A second mode of the present invention provides the cardiopulmonary resuscitation support device according to the first mode, wherein the at least one detection part comprises a plurality of detection parts provided in the pressure sensing part.

With the second mode, by detection parts being provided at a plurality of locations of the pressure sensing part, for example, it is possible to determine the compression position based on the detection results of each detection part, or to measure the compression volumes for the respective positions at which the detection parts are provided.

A third mode of the present invention provides the cardiopulmonary resuscitation support device according to the second mode, wherein the first electrode and the second electrode are arranged intersecting at a plurality of locations, and at each location where the first electrode and the second electrode intersect, the first electrode and the second electrode face each other sandwiching the dielectric layer to constitute the detection part.

With the third mode, by constituting the detection parts at intersecting locations at which the first electrode and the second electrode intersect each other, it is possible to provide detection parts at a plurality of locations with a simple structure. Also, by arranging the first electrode and the second electrode intersecting at a plurality of intersecting locations, even when a large number of detection parts are provided, it is possible to reduce the wiring and the like for transmitting detection signals of those detection parts, and to simplify the structure.

A fourth mode of the present invention provides the cardiopulmonary resuscitation support device according to the second or third mode, wherein the processing member calculates a chest compression position as the evaluation information based on the detection value of the electrostatic capacity detected by the detection parts obtained by the detection member.

With the fourth mode, by detecting the chest compression position based on the distribution of electrostatic capacity values and the like calculated based on changes in the electrostatic capacity detected by the detection parts, it is possible to know whether or not the chest compression position is suitable or not, or to know changes or skew of the compression position during cardiopulmonary resuscitation or the like. Therefore, a person giving life support who knows that kind of information can also correct as appropriate the compression position to a more suitable position based on that information.

A fifth mode of the present invention provides the cardiopulmonary resuscitation support device according to any one of the second to fourth modes, wherein the processing member calculates a ratio of a chest compression time in relation to an elapsed time of cardiac arrest as the evaluation information based on the detection value of the electrostatic capacity detected by the detection parts obtained by the detection member.

With the fifth mode, by calculating the ratio of the chest compression time to the cardiac arrest time of the person receiving life support, it is possible to determine the effectiveness of the life support. Specifically, since shortening the time until starting cardiopulmonary resuscitation using chest compression from recognition of cardiac arrest as well as continuously executing chest compressions are both important for improving the lifesaving rate and having a good prognosis, calculating this ratio as the evaluation information is effective.

A sixth mode of the present invention provides the cardiopulmonary resuscitation support device according to any one of the second to fifth modes, wherein the processing member selects the detection parts for which changes in electrostatic capacity of a threshold value or greater are detected, and based on the detection value of the electrostatic capacity detected by the detection parts selected, the processing member calculates at least one of the chest pressing depth during chest compression and the chest pressing depth during chest release.

With the sixth mode, there is a reduction in errors of the detection values due to differences in the compression surface area with the pressure sensing part, so with detection of chest pressing depth, errors in detection results due to differences in the size of the hands of the person giving life support, the chest compression position and the like is inhibited, so it is possible to detect the chest pressing depth stably and with good precision. For example, it is possible to calculate at least one of the chest pressing depth during chest compressions and the chest pressing depth during chest release based on the mean value of the electrostatic capacity detected by the selected detection parts, and as the mean value at that time, it is sufficient to grasp the overall output of the subject detection parts for which there were changes in electrostatic capacity of the threshold value or greater, and for example it is possible to use the arithmetic mean, the geometric mean, the harmonic mean or the like.

A seventh mode of the present invention provides the cardiopulmonary resuscitation support device according to any one of the first to sixth modes, wherein a surface area of the pressure sensing part is an average surface area or greater of a chest compression part on a palm of a person.

With the seventh mode, the surface area of the pressure sensing part is made large in relation to the surface area of the substantial chest compression part with the palm of the person giving life support, and when the person giving life support compresses the chest of the person receiving life support, even if there is a slight skew in the chest compression position, it is possible to effectively detect changes in the electrostatic capacity detected by the detection parts by compression and release. Preferably, by having the surface area of the pressure sensing part, which is for example the average surface area of the thenar part of the person's palm, be 900 mm² or greater, at least in a range for which cardiopulmonary resuscitation can be done effectively, even if the compression position is skewed, it is possible to effectively detect changes in the electrostatic capacity that accompany compression and release of the chest. With this mode, the subject person is a person assumed to perform implementation of cardiopulmonary resuscitation, and generally it is possible to use the average surface area of the chest compression part of the palm with the population being adult men and women.

An eighth mode of the present invention provides the cardiopulmonary resuscitation support device according to any one of the first to seventh modes, wherein the pressure sensing part is connected to be able to attach and detach freely in relation to the power supply device and the detection member.

With the eighth mode, by periodically exchanging the pressure sensing part that directly contacts the person giving life support and the person receiving life support after use or the like, for example, it is possible to maintain the sanitation of the pressure sensing part. Also, by exchanging of the pressure sensing part for which compression force is repeatedly input, it is possible to improve the reliability and durability of the cardiopulmonary resuscitation support device. In fact, by making the pressure sensing part which is preferably exchanged periodically freely attachable and detachable with the power supply device and the measurement means, it is possible to ensure sanitation, reliability and the like by doing a partial exchange without having to exchange the entire cardiopulmonary resuscitation support device.

A ninth mode of the present invention provides the cardiopulmonary resuscitation support device according to any one of the first to eighth modes, wherein at least one of the first electrode and the second electrode includes a grounded noise guard electrode.

With the ninth mode, the noise guard electrode prevents adverse effects (noise) that occur with detection by contact of at least one of the first electrode and the second electrode with the hand of the person giving life support or the chest of the person receiving life support, and detection accuracy is improved. The noise guard electrode can be provided with the pressure sensing part, but for example it is also possible for the noise guard electrode to be a separate part from the pressure sensing part, and to be arranged between the pressure sensing part and the hand of the person giving life support or the chest of the person receiving life support.

A tenth mode of the present invention provides the cardiopulmonary resuscitation support device according to any one of the first to ninth modes, wherein on at least one of the first electrode and the second electrode, a grounded noise guard electrode is overlapped via an insulator layer.

With the tenth mode, by the noise guard electrode kept at the reference potential being arranged between the hand of the person giving life support or the chest of the person receiving life support and the electrode, and by an insulator layer with a large dielectric constant being arranged between the noise guard electrode and the electrode, it is possible to prevent the constituting of a capacitor between the hand of the person giving life support or the chest of the person receiving life support and the electrode, thereby avoiding adverse effects (noise) on detection.

An eleventh mode of the present invention provides the cardiopulmonary resuscitation support device according to any one of the first to tenth modes, further comprising an aligning member that enables the pressure sensing part to be aligned on the chest.

With the eleventh mode, the pressure sensing part is aligned on a suitable position on the chest of the person receiving life support, so the person giving life support is able to do compression at the correct position on the chest of the person receiving life support if he does compression at the correct position of the pressure sensing part. Therefore, by performing cardiopulmonary resuscitation so as to have suitable values of the parameters of the chest compressions detected by the cardiopulmonary resuscitation support device, it is possible to do correct compression of the chest of the person receiving life support and to implement effective cardiopulmonary resuscitation.

A twelfth mode of the present invention provides the cardiopulmonary resuscitation support device according to any one of the first to eleventh modes, further comprising a notification member that outputs the evaluation information which is a calculation result of the processing member.

With the twelfth mode, the person giving life support or another person can easily grasp whether the cardiopulmonary resuscitation implemented by the person giving life support is good or not based on the evaluation information output by the notification member. The notification member is not particularly limited, and for example, it is possible to use various modes, including a sound or voice from a speaker, display of visual information on a monitor, lighting of a lamp or the like.

A thirteenth mode of the present invention provides the cardiopulmonary resuscitation support device according to the twelfth mode, wherein the notification member comprises a monitor display member that displays a skew of a chest compression position from a suitable position.

With the thirteenth mode, when performing cardiopulmonary resuscitation, the person giving life support visually recognizes the skew displayed on the monitor, making it easy to voluntarily correct the compression to a suitable chest compression position. When doing monitor display, to make it easy to recognize on the monitor, the chest compression position is displayed with a color that stands out such as red, yellow or the like, and it is even more preferable to display a cross point so as to easily understand the vertical and horizontal orientation for the suitable position on the chest lower half or the like. Naturally, the specific monitor display mode is not limited, and for example it is possible to display an arrow or text on the monitor for the direction needed to move the detected current chest compression position to a suitable position, or to display by arrow size or text on the monitor the required movement distance together with the direction. Also, when necessary, it is also possible to report the movement direction or distance using voice.

A fourteenth mode of the present invention provides the cardiopulmonary resuscitation support device according to the twelfth or thirteenth mode, wherein the notification member displays one of the detection value of the electrostatic capacity detected in the pressure sensing part and a value calculated based on the detection value of the electrostatic capacity in map form.

With the fourteenth mode, by displaying the electrostatic capacity detection values or values calculated based on the electrostatic capacity detection values in map form, the practitioner or assistant or the like can intuitively grasp information such as whether the cardiopulmonary resuscitation is good or not, improvement points or the like, and that contributes to more suitable cardiopulmonary resuscitation.

A fifteenth mode of the present invention provides the cardiopulmonary resuscitation support device according to any one of the first to fourteenth modes, further comprising: a wireless transmission member to wirelessly transmit as a transmission signal one of the detection value detected by the detection part and the evaluation information found by the processing member from the detection value; a wireless receiving member to receive the transmission signal; and a notification member that notifies the evaluation information based on the signal received by the wireless receiving member.

With the fifteenth mode, by wirelessly transmitting and receiving detection values and evaluation information signals, wiring becomes unnecessary, and it is possible to obtain information from any location as long as it is a distance for which wireless is effective. In particular, when implementing cardiopulmonary resuscitation while moving a person receiving life support or a training dummy model or the like on a stretcher or the like, it is not necessary to handle wiring, and by the person who is assisting the person giving life support wirelessly receiving detection values or evaluation information, he can more easily assist the person giving life support based on the received information. In fact, since having wiring fall out or the like due to vibration during moving can be avoided, it is also possible to improve reliability.

A sixteenth mode of the present invention provides the cardiopulmonary resuscitation support device according to the fifteenth mode, wherein the wireless receiving member comprises a mobile terminal.

With the sixteenth mode, by using a mobile terminal (mobile device) which has excellent portability as the wireless receiving member, the advantages of performing transmitting and receiving of information are made the most of, and receiving information at any location or moving while receiving information or the like becomes easy. In particular, even in a case when the assistant provides information to the person giving life support who is moving and assists with cardiopulmonary resuscitation, it is possible for the assistant to move while obtaining information with the mobile terminal, and assisting becomes easier.

A seventeenth mode of the present invention is the cardiopulmonary resuscitation support device according to any one of the first to sixteenth modes, further comprising: a determining member that does good or bad determination in regard to the evaluation information by using a determination value set for the evaluation information as a criterion; and a determination result notification member that notifies at least one good or bad determination result determined by the determining member.

With the seventeenth mode, it is possible for the person implementing cardiopulmonary resuscitation or the assistant to easily grasp whether or not the cardiopulmonary resuscitation being implemented or that was implemented is sufficiently suitable or not by the good or bad determination. Therefore, in particular with cardiopulmonary resuscitation training, it is easier to master effective cardiopulmonary resuscitation.

An eighteenth mode of the present invention provides the cardiopulmonary resuscitation support device according to the seventeenth mode, further comprising an advice member that, according to the good or bad determination result determined by the determining member, notifies a course of action for changing the determination result to be good when the determination result is bad.

With the eighteenth mode, according to the course of action for change shown with the advice member, by changing the compression depth or rhythm, the length of the recoil time, the duty cycle or the like, it is possible to relatively easily implement effective cardiopulmonary resuscitation.

A nineteenth mode of the present invention provides the cardiopulmonary resuscitation support device according to the seventeenth or eighteenth mode, wherein the at least one good or bad determination result comprises a plurality of good or bad determination results, and a chest compression time for which at least one good or bad determination result determined by the determining member is good based on the evaluation information is calculated as a ratio in relation to an elapsed time of cardiac arrest.

With the nineteenth mode, by identifying the length of time for which cardiopulmonary resuscitation by chest compression has been executed effectively to some degree using the good or bad determination results by the determining member, it is possible to grasp the ratio of the time for which effective cardiopulmonary resuscitation has been implemented with the elapsed time of cardiac arrest. With this mode, since the time for which chest compressions are done is identified with the fact that the good or bad determination results based on at least one evaluation information are good as criteria, for example, even for a person giving life support whose proficiency level of cardiopulmonary resuscitation is low, it is possible to grasp the ratio to the time for which relatively effective chest compressions were implemented.

A twentieth mode of the present invention provides the cardiopulmonary resuscitation support device according to the nineteenth mode, wherein the chest compression time for which all the good or bad determination results determined by the determining member are good based on the evaluation information is calculated as the ratio in relation to the elapsed time of cardiac arrest.

With the twentieth mode, by the length of the time for which cardiopulmonary resuscitation using chest compressions was executed with sufficient efficiency being identified by the good or bad determination results by the determining member, it is possible to grasp the ratio of the time for which effective cardiopulmonary resuscitation was implemented with respect to the elapsed time of the cardiac arrest. With this mode, the time for which chest compressions were done is identified with all the good or bad determination results based on the evaluation information being good as criteria, so for example it is possible to guide a person giving life support with a high proficiency level in cardiopulmonary resuscitation to a higher level of cardiopulmonary resuscitation mastery.

A twenty-first mode of the present invention provides the cardiopulmonary resuscitation support device according to any one of the first to twentieth modes, further comprising a positioning member that positions the pressure sensing part on the chest.

With the twenty-first mode, the pressure sensing part is positioned on the chest by the positioning member, so even when the pressure sensing part is compressed repeatedly, skew of the pressure sensing part on the chest is prevented, and it becomes easier to implement cardiopulmonary resuscitation suitably. In particular, when cardiopulmonary resuscitation is implemented while moving with a stretcher, ambulance, helicopter or the like, problems such as the pressure sensing part being skewed on the chest or falling from the chest due to vibration during moving are avoided.

A twenty-second mode of the present invention provides the cardiopulmonary resuscitation support device according to any one of the first to twenty-first modes, wherein the pressure sensing part is used by being mounted on a training dummy.

With the twenty-second mode, by using the cardiopulmonary resuscitation support device of the present invention for training, it becomes easier to master correct cardiopulmonary resuscitation based on evaluation information, and it is possible to perform training efficiently. In fact, with a cardiopulmonary resuscitation support device having a flexible pressure sensing part, there is a decrease in the sense of unfamiliarity due to working via the pressure sensing part when doing chest compressions. Thus, when performing cardiopulmonary resuscitation as an actual lifesaving activity after training, the difference from training is small, and it is possible to do implementation in the same manner as during training.

A twenty-third mode of the present invention provides the cardiopulmonary resuscitation support device according to the twenty-second mode, further comprising: a determining member that does good or bad determination in regard to the evaluation information by using a determination value set for the evaluation information as a criterion; and an evaluation result display member that displays a good or bad determination result determined by the determining member after compression on the pressure sensing part ends.

With the twenty-third mode, the person performing cardiopulmonary resuscitation as training is able to correctly recognize items to be improved by viewing good or bad determination results after training. By so doing, more efficient training is achieved, and it is possible to improve the cardiopulmonary resuscitation technique more quickly.

According to the present invention, with the cardiopulmonary resuscitation support device, since the pressure sensing part overlapped on the chest is a flexible capacitance type sensor, by the pressure sensing part deforming along the irregularities of the chest, it is easier to hold the device on the chest. Besides, even with chest compressions via the pressure sensing part, it is possible to have a sense close to that of direction compression of the chest when implementing cardiopulmonary resuscitation, and further, to avoid pain or the like due to contact with the pressure sensing part.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a plan view showing a cardiopulmonary resuscitation support device as a first embodiment of the present invention;

FIG. 2 is a perspective exploded view of a sensor main unit of the cardiopulmonary resuscitation support device shown in FIG. 1;

FIG. 3 is a vertical cross section view of the sensor main unit shown in FIG. 2;

FIG. 4 is a drawing suitable for explaining the use state shown with the cardiopulmonary resuscitation support device shown in FIG. 1 mounted on a training dummy;

FIGS. 5A and 5B are distribution drawings showing the distribution of detection signals detected during compression of a pressure sensing part of the cardiopulmonary resuscitation support device shown in FIG. 1, where FIG. 5A shows a case of weak compression at an unsuitable position, and FIG. 5B shows a case of strong compression at a suitable position;

FIGS. 6A and 6B are plan views specifically showing the pressure sensing part of the cardiopulmonary resuscitation support device shown in FIG. 1, where FIG. 6A shows the state with the center part of the pressure sensing part compressed, and FIG. 6B shows the state with the outer circumference end part of the pressure sensing part compressed;

FIG. 7 is a graph specifically showing the detection results during use of the cardiopulmonary resuscitation support device shown in FIG. 1;

FIGS. 8A and 8B are graphs specifically showing the detection results during use of the cardiopulmonary resuscitation support device shown in FIG. 1, where FIG. 8A shows a case when the detection data acquisition interval is suitable, and FIG. 8B shows a case when the detection data acquisition interval is too long;

FIG. 9 is a drawing showing an example of the detection values of the electrostatic capacity displayed on the monitor in real time during execution of cardiopulmonary resuscitation using the cardiopulmonary resuscitation support device shown in FIG. 1;

FIGS. 10A and 10B are display examples showing the detection results during use of the cardiopulmonary resuscitation support device shown in FIG. 1 in map form, where FIG. 10A shows a case when the frame rate is suitable, and FIG. 10B shows a case when the frame rate is unsuitable;

FIG. 11 is a drawing showing an example of good or bad determination results displayed on the monitor after the end of cardiopulmonary resuscitation using the cardiopulmonary resuscitation support device shown in FIG. 1;

FIG. 12 is a drawing suitable for explaining the use state shown with a cardiopulmonary resuscitation support device as a second embodiment of the present invention mounted on a training dummy; and

FIG. 13 is a drawing suitable for explaining the use state shown with a cardiopulmonary resuscitation support device as another embodiment of the present invention mounted on a training dummy.

### DETAILED DESCRIPTION OF PREFERRED EMBODIMENTS

Following, we will describe embodiments of the present invention while referring to drawings.

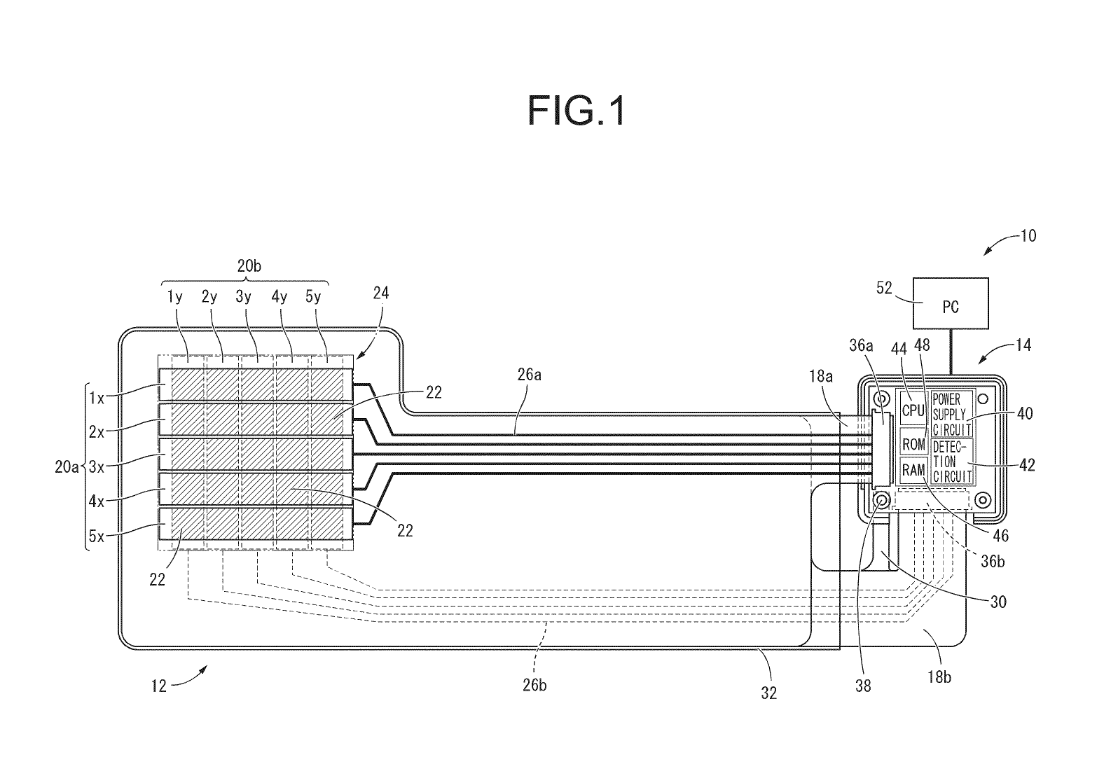

FIG. 1 shows a cardiopulmonary resuscitation support device 10 as a first embodiment of the present invention. The cardiopulmonary resuscitation support device 10 is used for cardiopulmonary resuscitation using chest compressions, and is equipped with a sensor main unit 12 overlapped on the chest for detecting chest compressions, and a sensor controller 14 for performing processing of detection results of the sensor main unit 12 or the like.

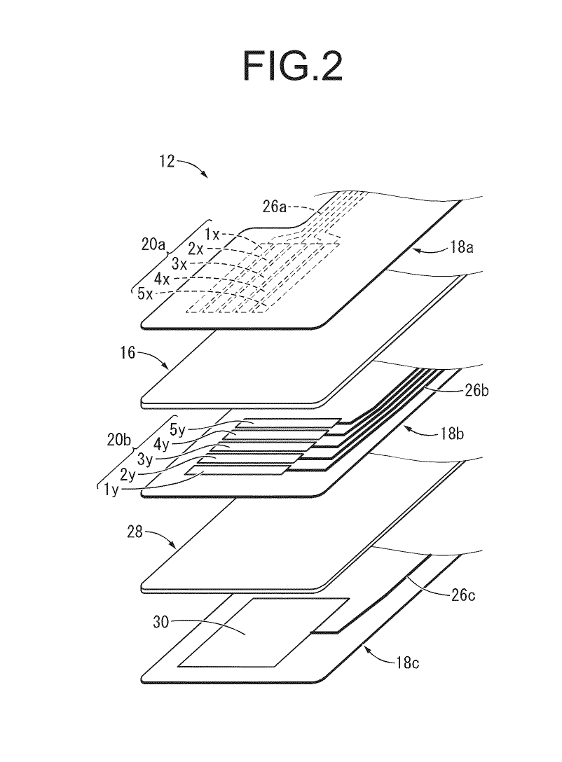

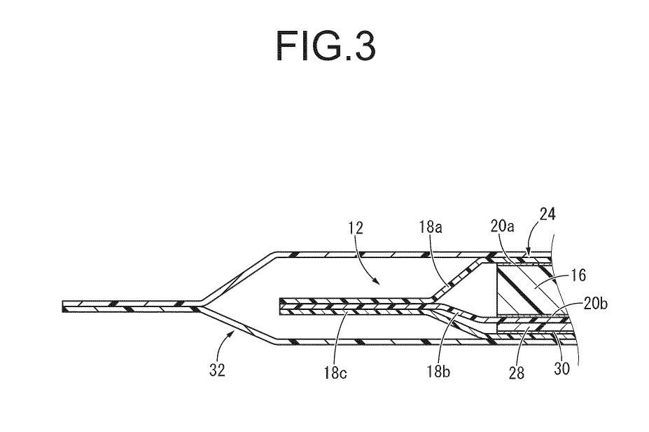

As shown in FIGS. 2 and 3, the sensor main unit 12 has a structure for which an elastomer sheet 18a is overlapped on one surface of a dielectric layer 16, and an elastomer sheet 18b is overlapped on the other surface of the dielectric layer 16.

The dielectric layer 16 is formed using an electrically insulating elastomer such as rubber, resin or the like, has a plate shape or sheet shape, has elasticity or flexibility, can be deformed by expansion and contraction, and in particular can be easily deformed in the thickness direction. As the forming material of the dielectric layer 16, for example, it is preferable to use silicone rubber, acrylonitrile-butadiene copolymer rubber, acrylic rubber, epichlorohdyrin rubber, chlorosulfonated polyethylene, chlorinated polyethylene, urethane rubber, polyethylene resin, polypropylene resin, polyurethane resin, polystyrene resin, polyvinyl chloride-polyvinylidene chloride copolymer, ethylene-acetic acid copolymer or the like. Furthermore, the dielectric layer 16 can also be foam, and as long as the necessary dielectric constant and flexibility are ensured, that foam is not limited to being an item that exhibits a homogenous phase with independent bubbles, but for example can also exhibit a non-uniform phase by continuous bubbles being formed. Also, the thickness and forming material of the dielectric layer 16 and the like are suitably set according to the specific dielectric constant and flexibility found with detection parts 22 described later.

Also, electrodes 20a are provided on the elastomer sheet 18a as the first electrode, and electrodes 20b are provided on the elastomer sheet 18b as the second electrode. The electrodes 20a and 20b are, for example, formed using a flexible conductive elastomer for which a conductive filler (e.g. carbon black, a metal powder such as silver powder or the like) is added to an elastomer such as rubber, resin or the like, and is easily deformable. As the elastomer which is the forming material of the electrodes 20a and 20b, it is preferable to use, for example, silicone rubber, ethylene-propylene copolymer rubber, natural rubber, styrene-butadiene copolymer rubber, acrylonitrile-butadiene copolymer rubber, acrylic rubber, epichlorohydrin rubber, chlorosulfonated polyethylene, chlorinated polyethylene, urethane rubber, polyester resin, polyether urethane resin, polycarbonate urethane resin, vinyl chloride-vinyl acetate copolymer, phenol resin, acrylic resin, polyamide-imide resin, polyamide resin, nitrocellulose, modified cellulose or the like. Also, the elastomer sheets 18a and 18b are formed using the same elastomer as the electrodes 20a and 20b, for example. The elastomer sheets 18a and 18b of this embodiment are transparent or semi-transparent for easier understanding, but they do not have to be transparent.

Furthermore, the electrodes 20a and 20b have a thin walled, long band shape, and at the orthogonal two axes x-y plane, five electrodes 20a extending in parallel to the x axis are arranged provided on the elastomer sheet 18a, and five electrodes 20b extending in parallel to the y axis are arranged on the elastomer sheet 18b. Also, by the elastomer sheet 18a being overlapped on one surface of the dielectric layer 16, the electrodes 20a are arranged between the dielectric layer 16 and the elastomer sheet 18a. By so doing, lx to 5x of the electrodes 20a are overlapped on one surface of the dielectric layer 16, while extending in parallel to each other. Meanwhile, by the elastomer sheet 18b being overlapped on the other surface of the dielectric layer 16, the electrodes 20b are arranged between the dielectric layer 16 and the elastomer sheet 18b. By so doing, 1y to 5y of the electrodes 20b are overlapped on the other surface of the dielectric layer 16, while extending orthogonal to the electrodes 20a and in parallel to each other. With this arrangement, the electrodes 20a and the electrodes 20b are arranged intersecting at a plurality of locations, and at the facing parts where the electrodes 20a and 20b intersect, capacitors are constituted, and detection parts 22 are formed which are used as the capacitance type sensors for which it is possible to detect input based on changes in the electrostatic capacity of the capacitor. It is acceptable to provide only one detection part 22, but with this embodiment, by arranging electrodes 20a and electrodes 20b intersecting at a plurality of locations, a plurality of detection parts 22 are dispersed and provided. Also, with the plan view shown in FIG. 1, the dielectric layer 16 is formed in a shape that is roughly the same or larger than the arrangement region of the electrodes 20a and 20b with the elastomer sheets 18a and 18b, and with all the detection parts 22, the dielectric layer 16 is sandwiched between the electrodes 20a and 20b. With FIG. 1, to make it easier to understand, the detection parts 22 are shown with diagonal cross hatching.

At the intersecting parts of these electrodes 20a and 20b (detection parts 22), when the dielectric layer 16 is deformed by compression in the layering direction of the dielectric layer 16 and the elastomer sheets 18a and 18b, the facing distance between the electrodes 20a and 20b becomes shorter, so the electrostatic capacity of that part changes. Therefore, using the sensor controller 14 comprising an electrical control device, it is possible to detect changes in the electrostatic capacity with each detection part 22, which makes it possible to detect changes in the facing distance of the electrodes 20a and 20b with each detection part 22, so that a pressure sensing part 24 is constituted. Specifically, each intersecting part of the electrodes 20a and 20b (detection part 22) can function as an electrostatic capacity type detection element (cell). With the detection parts 22, the changes in electrostatic capacity that accompany changes in the facing distance of the electrodes 20a and 20b are detected, and it is also possible to detect changes in the electrostatic capacity by changes in the substantial facing surface area by the expansion and contraction or relative displacement in the surface direction of the electrodes 20a and 20b. Specifically, during the chest compressions described later, not only are changes in the electrostatic capacity accompanying changes in the facing distance detected, but it is also possible to detect changes in electrostatic capacity due to relative displacement in the surface direction or expansion and contraction.

The pressure sensing part 24 of this embodiment is a capacitance type sensor for which 25 detection parts 22 are arranged two dimensionally in 5 columns x 5 rows, thus constituting the sensor main unit 12. Also, the surface area of the pressure sensing part 24 is the average surface area or greater of the chest compression part of a person's palm. Preferably, for example, it is the average surface area (e.g. about 900 mm²) or greater of the thenar (the part of the palm that rises up at the base attachment part of the thumb) which is the substantial chest compression part of a person's hand, and this makes it possible to sufficiently handle skew of the compression position. Also, more preferably, by having it be the average surface area or greater than the overall palm of a person, it is also possible to confirm whether or not pressing is occurring at a suitable part of the palm. In FIG. 1, to make it easier to understand, the pressure sensing part 24 is shown virtually with a double dot-dash line.

Also, the elastomer sheets 18a and 18b expand further to the outside than the arrangement region of the electrodes 20a and 20b (pressure sensing part 24), and at further to the outside than the electrodes 20a and 20b of the elastomer sheets 18a and 18b, the respective wires 26a and 26b are printed by conductive material. Also, the wires 26a are connected to the electrodes 20a, and the wires 26b are connected to the electrodes 20b. The wires 26a and 26b can be made into a wiring pattern printed using conductive ink on the elastomer sheets 18a and 18b, for example. Furthermore, the electrodes 20a and 20b can also be formed by printing on the elastomer sheets 18a and 18b the same as with the wires 26a and 26b using conductive ink formed from a conductive elastomer. Also, the elastomer sheets 18a and 18b are mutually adhered using an adhesive agent, double sided tape or the like at the outer circumference end part separated from the region at which the electrodes 20a and 20b are arranged and the region at which the wires 26a and 26b are formed.

Also, an insulator layer 28 is overlapped on the elastomer sheet 18b. The insulator layer 28 is formed using a soft synthetic resin, a rubber elastic body or the like having electric insulation properties in addition to flexibility and expansion and contraction properties. The insulator layer 28 has a sheet form or plate form, and is overlapped on the opposite side to the dielectric layer 16 in relation to the elastomer sheet 18b. As the forming material of the insulator layer 28, it is preferable to use polyethylene, urethane rubber or the like.

Furthermore, a noise guard electrode 30 provided on an elastomer sheet 18c is overlapped on the insulator layer 28. The noise guard electrode 30 is formed in a thin film form using a conductive elastomer that is flexible and can expand and contract, the same as the electrodes 20a and 20b, and is overlapped on the side opposite to the elastomer sheet 18b in relation to the insulator layer 28. By so doing, the noise guard electrode 30 is overlapped via the insulator layer 28 on the electrodes 20b of the elastomer sheet 18b, and is electrically insulated by the insulator layer 28.

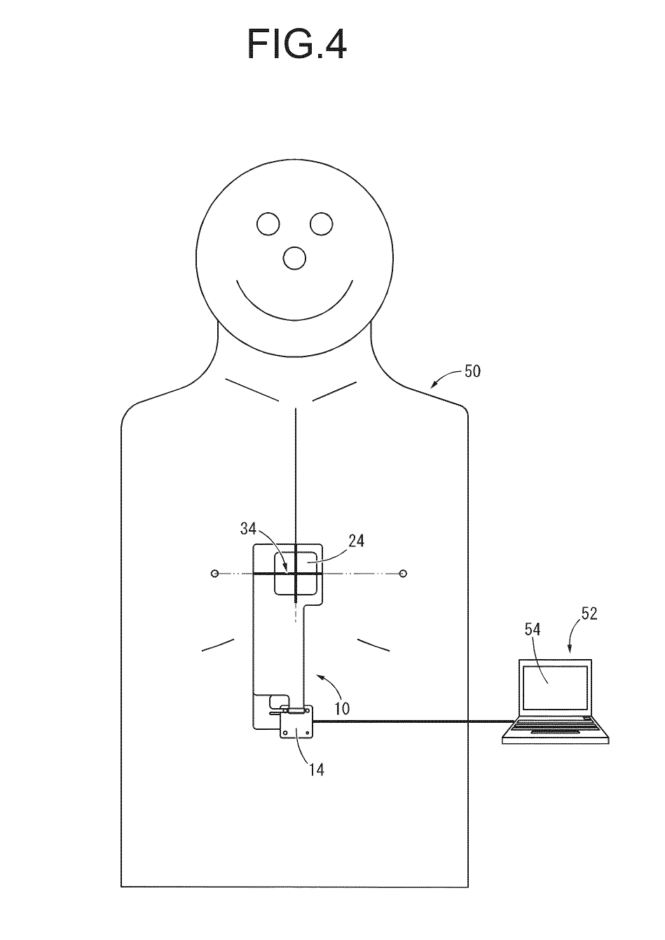

Next, we will describe FIG. 3. The sensor main unit 12 of this embodiment is covered by a cover 32. The cover 32 is formed using cloth, a rubber elastic body, a soft synthetic resin or the like, and has a bag shape for which a front side sheet and a back side sheet are adhered to each other at the outer circumference part, and housed in this is the sensor main unit 12 constituted by the dielectric layer 16, the elastomer sheets 18a and 18b, the insulator layer 28, and the noise guard electrode 30. Furthermore, on the front surface of the cover 32 (the front surface of the side covering the elastomer sheet 18a), a compression point illustration 34 is depicted as the aligning member, making it possible to easily do alignment on the chest using the compression point illustration 34 (see FIG. 4). With FIG. 1, to make it easier to see the sensor main unit 12 inside the cover 32, the cover 32 is illustrated in a see through state.

Also, the wires 26a connected to the electrodes 20a are connected to a connector 36a provided on the sensor controller 14 as the processing member, and the electrodes 20a are electrically connected to the sensor controller 14 via the wires 26a. Meanwhile, the wires 26b connected to the electrodes 20b are connected to a connector 36b of the sensor controller 14, and the electrodes 20b are electrically connected to the sensor controller 14 via the wires 26b. Also, the wire 26c connected to the noise guard electrode 30 is connected to a grounding terminal 38 provided on the sensor controller 14, the noise guard electrode 30 is grounded, and the electrical potential of the noise guard electrode 30 is used as the reference potential. The wires 26a and 26b are connected to be able to be attached and detached with connectors 36a and 36b of the sensor controller 14 respectively, and the sensor main unit 12 equipped with the pressure sensing part 24 is connected to be able to be freely attached and detached with the sensor controller 14.

As shown in FIG. 1, for example, this sensor controller 14 is equipped with a power supply circuit 40 for supplying operating voltage serving as the power supply device and a detection circuit 42 for detecting or obtaining electrostatic capacity serving as the detection member, which are connected via the connectors 36a and 36b to the electrodes 20a and 20b respectively. The power supply circuit 40 selectively performs power feed to 1x to 5x of the electrodes 20a and 1y to 5y of the electrodes 20b, and under control by a central processing unit (CPU) 44, at each intersecting part at 25 locations constituting the capacitors, periodic waveform voltage is applied in scanning form as measurement voltage.

Also, the detection signals of the electrostatic capacity detected under this voltage action are detected in sequence by a detection circuit 42, and the detection values are stored in a RAM (random access memory) 46. Detection of electrostatic capacity by the detection circuit 42 is performed by finding the electrostatic capacity values using the impedance found from the current values, for example.

Also, the characteristics data of the capacitors constituted by the intersecting parts of the electrodes 20a and 20b are stored in a ROM (read only memory) 48, and based on this characteristics data, using the CPU 44, it is possible to find the compression force that is the external force applied to the intersecting parts of the electrodes 20a and 20b from the detection values of the electrostatic capacity found excluding the effect of wiring resistance. With FIG. 1, to make it easy to understand, the power supply circuit 40, the detection circuit 42, the CPU 44, the RAM 46, and the ROM 48 are illustrated as functional blocks of the sensor controller 14.

Therefore, by respectively scanning the electrostatic capacity detected by the 25 detection parts 22 constituted by the intersecting parts of the electrodes 20a and 20b constituting the capacitors, it is possible to detect the two dimensional distribution of electrostatic capacity values overall. It is also possible to obtain the two dimensional distribution of the compression force based on the electrostatic capacity detection value.

The cardiopulmonary resuscitation support device 10 constituted as described above is used during implementation of cardiopulmonary resuscitation using chest compression for life support or life support training, for example. Following, we will describe specific use examples for life support training.

First, as shown in FIG. 4, a training dummy 50 as a person receiving life support simulating the entire body or the upper half of the body is placed lying down on a stretcher or a floor, and the pressure sensing part 24 of the cardiopulmonary resuscitation support device 10 is overlapped and mounted on the chest of the training dummy 50. With this embodiment, so as to align the chest compression points on the training dummy 50 using the compression point illustration 34 as the aligning member drawn on the surface of the cover 32 that covers the pressure sensing part 24, the pressure sensing part 24 is aligned on the chest of the training dummy 50. Also, the pressure sensing part 24 can only be laid without adhesion on the chest of the training dummy 50, but for example, it is also possible to have the pressure sensing part 24 positioned and held at a designated position on the chest of the training dummy 50 by adhering the cover 32 that covers the pressure sensing part 24 to be able to be attached and detached to the training dummy 50 using a positioning member such as double sided tape, a surface fastener, snaps or the like. As the positioning member for positioning the pressure sensing part 24 on the chest, aside from the items shown by example above, for example, it is possible to selectively use or use in any combination various fixing modes such as adhesion using a spray glue or adhesive agent, an adhesive polymer, an adhesive cloth or the like, heat sealing, engaging of the outer circumference part, fixing using a stapler, fixing of the circumference edge part using tape, fastening with a pin, fixing using a rivet, fastening using a screw, fixing using a clamp, band fastening, fixing using a clip, fitting in a recess provided on the surface of the dummy 50, fastening using string, dent and bump engaging of the overlapping surface using an elastomer or the like, for example. The pressure sensing part 24 can be fixed so as not to be able to be removed on the chest of the training dummy 50, but preferably, it is positioned so as to be able to be attached and detached. Also, the positioning member can position and fix the entire pressure sensing part 24, but it is also possible to partially fix one location or a plurality of locations of the pressure sensing part 24.

When doing positioning with a positioning member such as the surface fastener, snaps or the like as noted above, the compression point illustration 34 is not absolutely necessary, and for example it is also possible to constitute the aligning member by mutual positions of a surface fastener or snap provided on the back surface of the cover 32 and the chest front surface of the training dummy 50. Also, with this embodiment, the compression point illustration 34 is lines intersecting as a cross, and by aligning this on the lateral center of the training dummy 50 and the virtual line that connects the nipples (double dot-dash line in FIG. 4), the pressure sensing part 24 is positioned on the chest of the training dummy 50, but the compression point illustration 34 is not limited to being cross shaped lines.

Next, a power supply switch (not illustrated) of the sensor controller 14 is switched from off to on, and supplying of power to the electrodes 20a and 20b by the power supply circuit 40 is started, and detection of electrostatic capacity by the detection circuit 42 is started.

Also, the person training as a person giving life support (not illustrated) does compressions of the chest of the training dummy 50 from above the pressure sensing part 24, and implements cardiopulmonary resuscitation using chest compressions on the training dummy 50. Because it is flexible overall, the pressure sensing part 24 is freely deformed according to downward pressing of the chest of the training dummy 50 or deformation of the hand of the person doing training by the action of the compression force. Therefore, the person doing training feels almost no sense of unfamiliarity at all due to working via the pressure sensing part 24, and it is possible to execute cardiopulmonary resuscitation with almost the same sense as when doing compressions directly on the chest.

Also, when the person doing training compresses the chest of the training dummy 50 via the pressure sensing part 24, with the detection part 22 compressed by the hands of the person doing training, the distance between the facing surfaces of the electrodes 20a and 20b becomes smaller. As a result, the electrostatic capacity detected by that detection part 22 becomes greater, and the change in electrostatic capacity is detected by the detection circuit 42.

Also, the detection signals of the electrostatic capacity detected by each detection part 22 detected by the detection circuit 42 are transmitted from the detection circuit 42 to the processing member (CPU 44, RAM 46, ROM 48), and are used for calculating various types of parameters for evaluating cardiopulmonary resuscitation by the person doing training. In addition to whether or not the compression position on the chest of the training dummy 50 is suitable, as evaluation information, the processing member of this embodiment also calculates the pressing depth during compression, the pressing depth during release, the compression time ratio (Duty Cycle, DC), the number of compressions, the number of compressions per minute (bpm), and the fraction of chest compression time to the cardiac arrest time (Chest Compression Fraction, CCF). Following, we will show an example of the calculation method for each parameter.

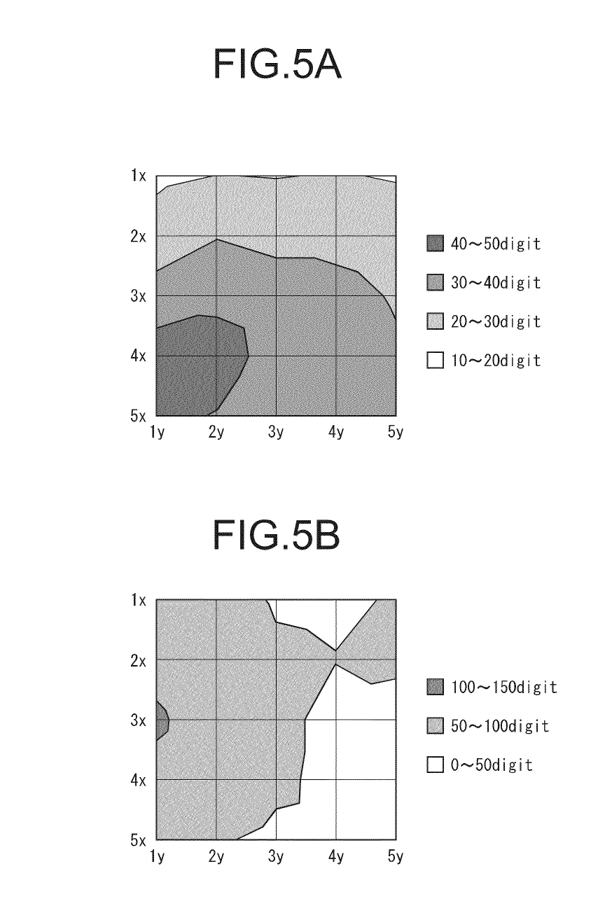

More specifically, based on the electrostatic capacity detection value detected by each detection part 22, the distribution of the electrostatic capacity with the pressure sensing part 24 is found (see FIGS. 5A and 5B). Also, the detection part 22 for which the electrostatic capacity change volume was greatest is positioned at the outer circumference end of the pressure sensing part 24, and when the detected electrostatic capacity is a preset threshold value or less (FIG. 5A), it is determined that the compression position is at an unsuitable position away from the pressure sensing part 24. On the other hand, when the detection part 22 for which the electrostatic capacity change volume was greatest is positioned at other than the outer circumference end of the pressure sensing part 24, or it is positioned at the outer circumference end and the detected electrostatic capacity exceeds a preset threshold value (FIG. 5B), it is determined that a suitable position near that detection part 22 is being compressed. According to the above, the compression position on the chest of the training dummy 50 is calculated, and a determination is made of whether the compression position is suitable or not. Furthermore, by calculating the compression position, it is possible to confirm the difference (distance) between the suitable compression position and the actual compression position, so it is possible to easily grasp the compression position correction volume, and possible to perform training efficiently. With this embodiment, when it is determined that the compression position is away from the suitable position, by notifying the person doing training by displaying text or an image or the like on a monitor display member (monitor 54 of a personal computer 52 described later) as the notification member, a change in compression position is prompted. Naturally, the notification member is not limited to being a monitor display member, and as long as it is an item that makes the person doing training aware of a skew in the compression position, it can also be a voice, lighting of a light or the like.

FIGS. 5A and 5B are examples showing the strength (voltage) of the electrostatic capacity detection signals transmitted from the pressure sensing part 24 to the sensor controller 14 as a distribution map, where the scale of the vertical axis shows 1x to 5x of the electrodes 20a, the scale of the horizontal axis shows 1y to 5y of the electrodes 20b, and the vertical axis and horizontal scale crossing points show each detection part 22. FIG. 5A is a case of implementation of cardiopulmonary resuscitation that is not effective, and from the detection signal strength and its distribution, we can see that the compression position is near the crossing point of 5x of the electrode 20a and 1y of the electrode 20b which is away from the suitable position, and that the maximum value of the detection signal is 40 to 50 digits which is compression of insufficient force. On the other hand, FIG. 5B is a case of implementation of effective cardiopulmonary resuscitation, and from the detection signal strength and its distribution, we can see that the compression position is near the crossing point of 3x of the electrode 20a and 1y of the electrode 20b which is a suitable position, and that the maximum value of the detection signals is 100 to 150 digits which is compression of sufficiently large force.

Also, the pressing (compression) depth during compression and during release is calculated as follows, for example. Specifically, detection parts 22 for which the electrostatic capacity change volume exceeds a preset threshold value are selected, and after calculating the sum of the electrostatic capacity detected by those detection parts 22, based on the value for which the sum of the electrostatic capacity is divided by the number of selected detection parts 22, the average value of the electrostatic capacity or pressing force detected with the selected detection parts 22 is calculated. Based on this average value, by calculating the pressing volume from the initial state of the chest of the training dummy 50, it is possible to find the pressing depth during compression and during release. Specifically, by finding the deformation characteristics of the training dummy 50 in relation to pressure force (including pressing characteristics and restoration characteristics) in advance from data such as of tests, calculations or the like as mathematical functions, map data or the like, it is possible to calculate the deformation of the training dummy 50 accompanying compression and release. Calculation of the pressing depth is not necessarily limited to being based on the average value of the detected electrostatic capacity, but preferably, detection parts 22 exceeding a threshold value are selected, and calculation is done based on the detection values of the electrostatic capacity detected by the selected detection parts 22, and calculation based on the average value is one example of that.

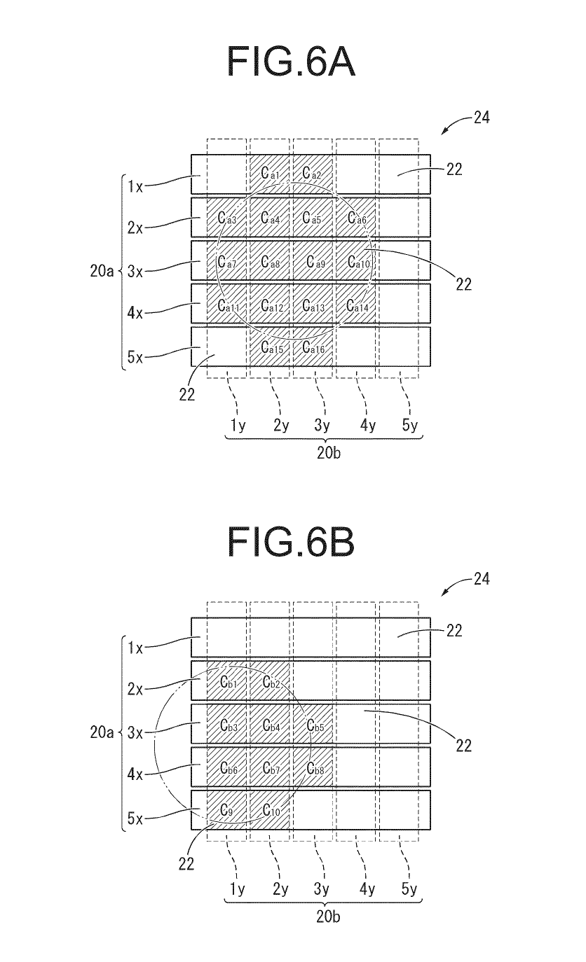

In more specific terms, when the center part of the pressure sensing part 24 is compressed as shown in FIG. 6A, 16 detection parts 22 shown with diagonal cross hatching in the drawing are selected, the sum of the electrostatic capacity detection values detected by those detection parts 22 (Cₐ₁+Cₐ₂+ . . . +Cₐ₁₆) is calculated, and the calculated value is divided by 16 which is the number of selected detection parts 22. Based on the numerical value of the calculation results, the average value of the electrostatic capacity detected with the 16 detection parts 22 is found, and the pressing depth is calculated based on the average value of this force. On the other hand, when the end part away from the center of the pressure sensing part 24 is compressed as shown in FIG. 6B, 10 detection parts 22 shown by diagonal cross hatching in the drawing are selected, the sum of the electrostatic capacity detection values detected by those detection parts 22 (C_{b1}+C_{b2}+ . . . +C_{b10}) is calculated, and the calculated value is divided by 10 which is the number of selected detection parts 22. Based on the numerical value of the calculation results, the average value of the electrostatic capacity detected by the 10 detection parts 22 is found, and the pressing depth is calculated based on this average value. In FIG. 6, the compression position by the palm of the person doing training is roughly shown using a double dot-dash line circle. In other words, the pressing depth is calculated based on the average value (Cₐᵥₑ) of the electrostatic capacity detection value found using Cₐᵥₑ=ΣCn/n. With the above formula, n is the number of selected detection parts 22.

In this way, if the chest pressing depth is calculated based on the average value for a plurality of detection parts 22 for which changes in electrostatic capacity of a designated value or greater are detected, for example when there is individual variation in the size of the palm of the person doing the training, or when as shown in FIG. 6B, a part of the hand of the person doing training compresses the chest at a position away from the pressure sensing part 24, there is a reduction in errors in detection results due to a difference in the compression surface area with the pressure sensing part 24 like those in FIG. 6A and FIG. 6B. With this embodiment, we showed an example of calculating the pressing depth based on the arithmetic mean of the electrostatic capacity detection values detected by the selected detection parts 22, but for example, it is also possible to calculate the pressing depth based on the geometric mean or harmonic mean of the electrostatic capacity detection value.

Using detection results of the size of the palm or the compression position skew, it is possible to find the chest pressing depth from the electrostatic capacity detection values. Specifically, a plurality of numerical formulas are prepared in advance for converting electrostatic capacity detection values to chest pressing depth according to detection results of the compression surface area or compression position, the average value of the electrostatic capacity detection values detected by all the detection parts 22 is calculated, and by selecting the conversion numerical formula according to detection results of the compression surface area or compression position, the difference in the detection values due to the difference in compression surface area or compression position is corrected, and the pressing depth can be found.

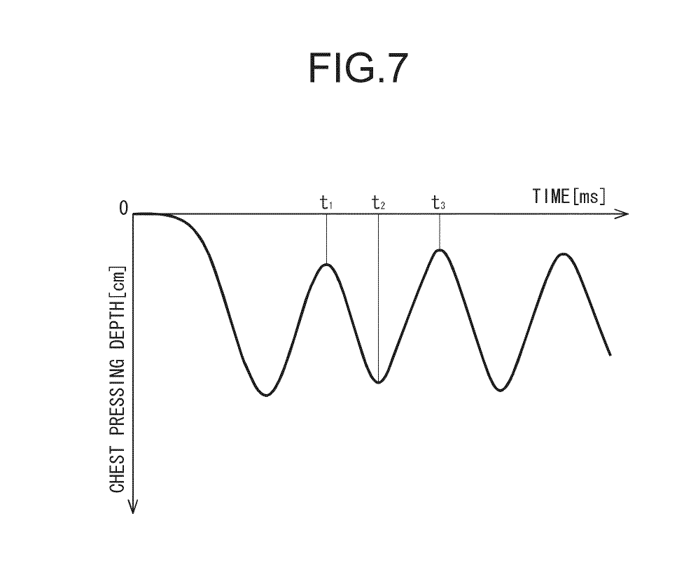

Also, by detecting compression from the released state (from t₁ to t₂ in FIG. 7) by an increase exceeding the electrostatic capacity threshold value, and detecting release from the compressed state (t₂ to t₃ in FIG. 7) by a decrease exceeding the electrostatic capacity threshold value, it is possible to detect the number of cardiopulmonary resuscitation cycles (number of compressions) with a compression and release as one unit (t₁ to t₃ in FIG. 7).

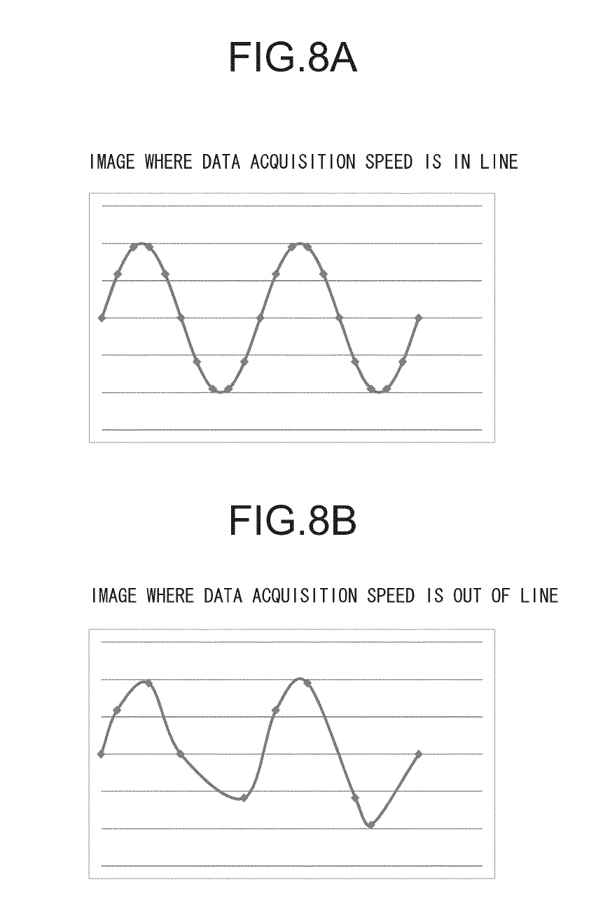

The graph in FIG. 7 shows in model form the changes of the compression depth calculated as described above in relation to the elapsing of time, where t₁ is the time after chest compressions when the chest is released until the pressing depth becomes the smallest, t₂ is the time after the t₁ chest release when the chest is compressed until the pressing depth becomes the greatest, and t₃ is the time after the t₂ chest compression when the chest is released until the pressing depth becomes the smallest. To accurately graph this kind of relationship between pressing depth and time, it is necessary to have the data acquisition interval (sampling rate) not be too long. This is because if the data acquisition interval is suitable, as shown in FIG. 8A, while the waveform showing the relationship between pressing depth and time is close to the changes in the actual pressing depth, if the data acquisition interval is too long, as shown in FIG. 8B, there is a risk that the waveform showing the relationship between pressing depth and time may greatly differ from the changes in actual pressing depth and not be very accurate. It is preferable that this kind of data acquisition interval be an interval that is 0.1 seconds or less for 80% or more of all the detection parts 22 (data acquisition of 10 frames or more for each second), and more preferable that it be an interval of 0.07 seconds or less (data acquisition of 15 frames or more for each second).

Furthermore, after compression from the released state, based on the time (t₃−t₁) required for one cycle until returning again to the released state, it is possible to calculate the rhythm of heart massage using chest compressions (number of compressions per unit of time). With FIG. 7, the units t₁, t₂, and t₃ are milliseconds, so for example the number of compressions (bpm) per minute is calculated by bpm={1/(t₃−t₁)}*1000*60.

Also, based on the calculation value for which the compression time for which the electrostatic capacity detected by the detection part 22 increases (t₂−t₁) is divided by the time needed for one cycle from the released state to compressing and returning again to the released state (t₃−t₁), it is possible to find the ratio of the compression time per cycle (duty cycle) as the percentage. In other words, the ratio (DC) of the compression time to one cycle can be calculated using DC={(t₂−t₁/(t₃−t₁)}*100 in FIG. 7.

Also, with this embodiment, the chest compression fraction (CCF) is also calculated. The CCF is the ratio of the chest compression time in relation to the time elapsed from when cardiac arrest was confirmed (elapsed time) of the person receiving life support calculated as a percentage. With training, cardiac arrest is confirmed at the training start, so by calculating the ratio of the chest compression time to the elapsed time from the start of training, it is possible to find the CCF. Typically, it is desirable to minimize suspension of chest compressions, so when performing a good or bad determination for the CCF using the determining member, for example, when the calculated CCF exceeds a preset threshold value, it is possible to have that be a good determination. For the chest compression time when calculating the CCF, time spent on lifesaving actions other than chest compressions are not included, such as the time from when cardiac arrest is confirmed until chest compressions are started, the time using an automated external defibrillator (AED), time when changing between persons executing the chest compressions and the like. Also, as the elapsed time when calculating the CCF, with normal lifesaving activity, this is the time from when cardiac arrest is confirmed until cardiopulmonary resuscitation is confirmed, and during training, the cardiac arrest time and the cardiopulmonary resuscitation time can be set freely according to the training contents. Furthermore, with the time from the cardiac arrest time at which cardiac arrest is confirmed until the cardiopulmonary resuscitation time at which cardiopulmonary resuscitation is confirmed as the elapsed time, it is possible to calculate the CCF after cardiopulmonary resuscitation ends, and with the time from the cardiac arrest time at which cardiac arrest is confirmed until the current point in time as the elapsed time, it is possible to calculate the real time CCF during execution of cardiopulmonary resuscitation. If the real time CCF calculated during cardiopulmonary resuscitation in this way is reported to the person giving life support, the person giving life support can perform cardiopulmonary resuscitation while being aware of the CCF, making it possible to do higher quality lifesaving activities.

Furthermore, with this embodiment, a good or bad determination is respectively performed for the compression position, the pressing depth, the rhythm, the recoil depth, and the duty cycle, and an effective chest compression time is found taking into consideration the good or bad determination results. Then, by calculating the ratio of the effective chest compression time in relation to the elapsed time from confirmation of cardiac arrest, the effective CCF is found. With this embodiment, the effective CCF is such that, by using an effective chest compression execution time for which all the good or bad determination results were determined to be good for each evaluation information including pressing depth, rhythm, recoil, duty cycle, and compression position, the ratio of the chest compression execution time in relation to the cardiac arrest time is calculated as a percentage. As with this embodiment, it is desirable to find the effective CCF as the effective chest compression time when the good or bad determination results are good for all the items, but for example, as long as the compression position is suitable, even if other items do not achieve a good determination, it is possible to expect an effect of cardiopulmonary resuscitation to some degree, so there are effective cases even when calculating the CCF based on the chest compression time for which the good or bad determination results of the compression position are good. In other words, when at least one of the aforementioned items has a good or bad determination result of good, it is possible to calculate the effective CCF by using the chest compression time at that time as an effective chest compression time.

From the above, it is possible to obtain each parameter that is important for cardiopulmonary resuscitation. Also, based on each of the obtained parameters, it is possible to evaluate and score the cardiopulmonary resuscitation performed by the person doing training. In specific terms, an ideal numerical value (determination value) is set in advance for each parameter, and based on the difference with actual detection values in relation to the set determination values, evaluation is done for each of the pressing depth during compression, pressing depth during release, the compression time ratio (duty cycle) and the number of compressions per minute (bpm), and a comprehensive evaluation of the cardiopulmonary resuscitation is done from the evaluation results of each parameter. As the determination value of each parameter, for example, it is possible to use numerical values proposed in CPR guidelines or the like, and in specific terms, the pressing depth during compression is 5 cm, the pressing depth during release is 0 cm, the compression time ratio is 50%, and the number of compressions per minute is 110 or the like. Also, we described this with a focus on one cycle of cardiopulmonary resuscitation, but since normal cardiopulmonary resuscitation is implemented continuously over a certain length of time, for example, it is possible to obtain the parameters noted above for each cycle, and to evaluate cardiopulmonary resuscitation based on the average value of all cycles.

The evaluation and scoring of the cardiopulmonary resuscitation as described above is notified to the person doing training for example by connecting a personal computer 52 to the sensor controller 14, displaying on a monitor 54 of the personal computer 52 the evaluation results, caution points and the like, or having them read using the speaker of the personal computer 52. By notifying evaluation results and the like using the personal computer 52 in this way, it is possible to give prompts for further improvements in cardiopulmonary resuscitation to the person doing training. Here, we showed an example of notifying the evaluation results after completion of cardiopulmonary resuscitation, but for example, by doing notification of the evaluation results successively during implementation of cardiopulmonary resuscitation, it is possible to prompt corrections in cardiopulmonary resuscitation during implementation and make improvements. As is clear from the description above, with this embodiment, the notification member for notifying the person doing training of evaluation information such as compression position skew, the evaluation results of the cardiopulmonary resuscitation or the like is constituted by the personal computer 52 connected to the sensor controller 14.

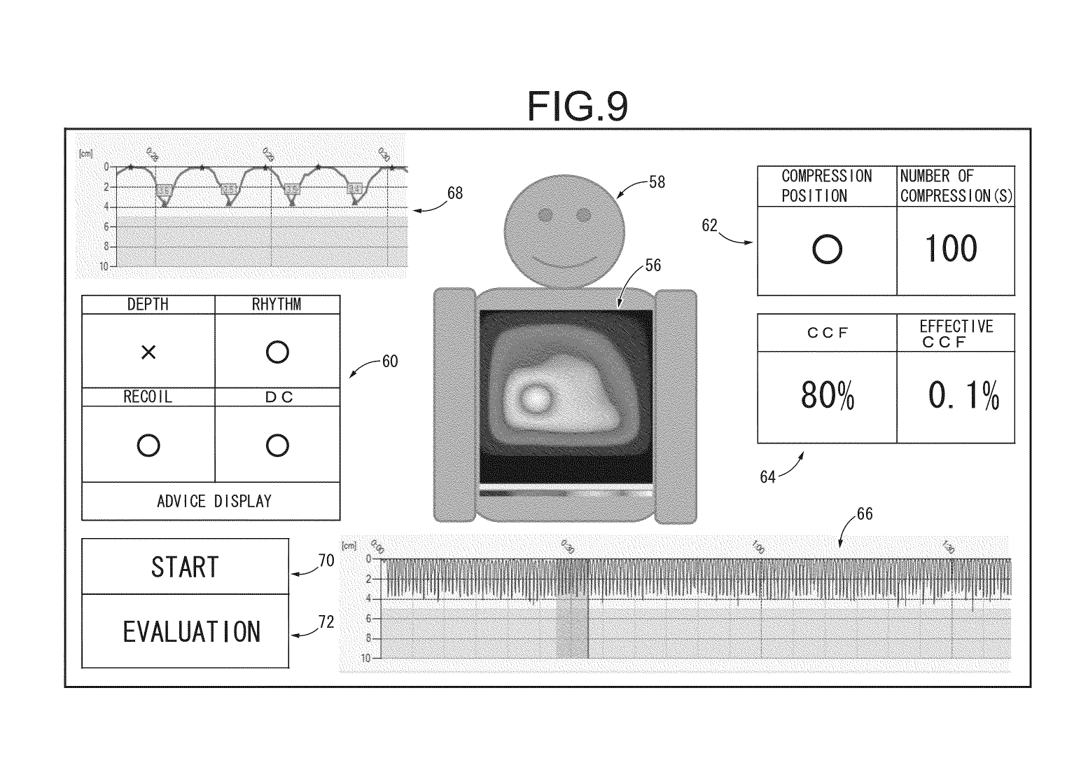

In more specific terms, as shown in FIG. 9, it is possible to display on the monitor 54 of the personal computer 52 as the notification member the evaluation information during implementation of cardiopulmonary resuscitation. Specifically, FIG. 9 shows an example of display of the monitor 54 of the personal computer 52, and in a detection value map display region 56 provided in the screen center, the pressing depth based on the electrostatic capacity detection values is displayed in real time in map form. Here, displayed in map form means displaying the electrostatic capacity detection values or the calculation values based on those so as to be shown on the detection value map display region 56 of FIG. 9 using contour lines, and by color coding, as distribution on a flat plane. Therefore, with the detection value map display region 56, there is color display with color coding according to the pressing depth, and it is possible to intuitively recognize the compression position and depth by the color distribution. In particular, as shown in FIG. 9, if displayed overlapped on a dummy illustration 58, since it is easy to understand the chest compression position and pressing depth distribution, in addition to whether or not the compression position and depth are suitable, when not suitable, it is also possible to easily grasp how to make a correction. It is also possible to make it possible to rotate the display of the detection value map display region 56, and for example by rotating it to match the orientation of the person receiving life support, it is possible to more intuitively grasp the compression position and pressing depth distribution.

With this embodiment, in the detection value map display region 56, the pressing depth based on the electrostatic capacity detection values is configured to be displayed in map form as distribution on a flat plane by contour lines and by color coding, but on the detection value map display region 56, it is also possible to display the distribution of the electrostatic capacity detection values or the values calculated based on the electrostatic capacity detection values (pressing depth and the like) on the pressure sensing part 24 flat plane. For example, it is possible to set a plurality of points dispersed on the flat plane correlating to the pressure sensing part 24, and display the electrostatic capacity detection values at the respective points. It is also possible to do mesh division of the flat plane correlating to the pressure sensing part 24, and to display detection values in each division. Naturally, it is preferable to be able to easily grasp the detection values by contour lines and color coding rather than displaying them as numerical values on the flat plane. Displaying the electrostatic capacity detection values or values calculated based on the electrostatic capacity detection values in map form means displaying on sites on the flat plane corresponding to the detection position on the pressure sensing part 24 colors, specific numerical values, symbols or the like according to the electrostatic capacity detection values or values calculated based on those.

When displaying in real time the detection value map display region 56 in this way, it is desirable to have the display of the detection value map display region 56 in relation to cardiopulmonary resuscitation be followed and updated with a delay within 0.15 seconds or less, and more preferable to have the display delay be within 0.1 seconds or less. By so doing, the person viewing the detection value map display region 56 does not sense a marked time delay of the display of the detection value map display region 56 in relation to the cardiopulmonary resuscitation activity, and can recognize this as real time information displayed without a sense of unfamiliarity. The display of the detection value map display region 56 does not necessarily have to be real time display corresponding to the progress of cardiopulmonary resuscitation, and in addition to display with a designated time delay, can also be display as a still image, which may be updated automatically at designated time intervals, or which may be updated or selected manually.

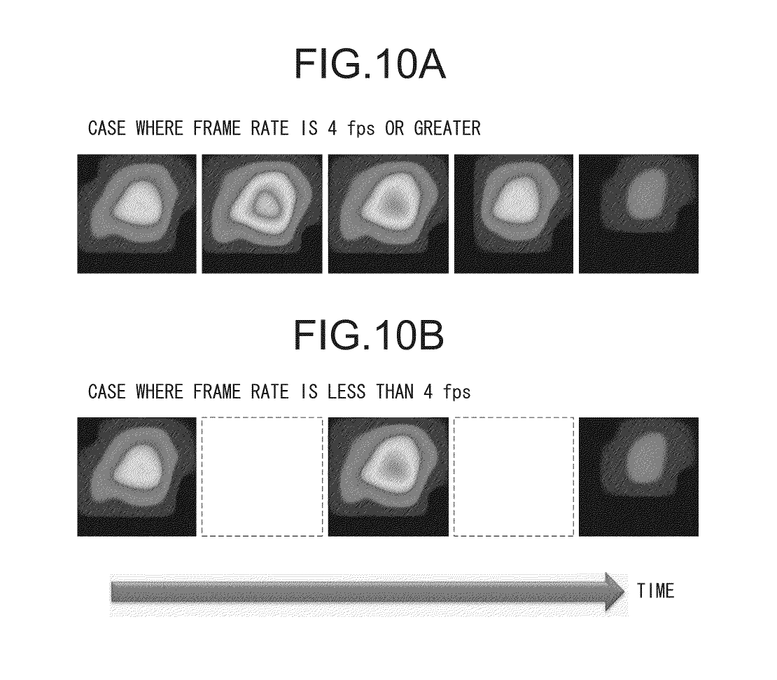

Furthermore, the frame rate of the map form display of the detection value map display region 56 is preferably 4 fps (frames per second) or greater, and more preferably 10 fps or greater. By so doing, as shown schematically in FIGS. 10A and 10B, the display of the detection value map display region 56 follows the action of the cardiopulmonary resuscitation action with good precision. Specifically, when the case of FIG. 10A for which the frame rate is 5 fps and the case of FIG. 10B for which the frame rate is 3 fps are compared, with FIG. 10B the second frame of FIG. 10A for which the compression force was maximum is not displayed, and it is not possible to accurately grasp the change in compression force. Therefore, with the number of frames per unit of time (frame rate) of the detection value map display region 56, to accurately grasp the shift in the cardiopulmonary resuscitation activity, it is better to have a high number. FIGS. 10A and 10B are cases of displaying changes in the same compression force, where it is shown that the second frame and fourth frame of FIG. 10A are not displayed with FIG. 10B due to the frame rate difference.

Also, with the monitor display of FIG. 9, an advice display region 60 for four items is provided in the left-side middle section. Specifically, a good or bad determination is made by using the determination values set by the personal computer 52, which serves as the determining member, as the criteria in regard to the items (evaluation information of pressing depth, number of compressions per minute (rhythm), chest release (recoil), and compression time percentage (duty cycle, DC), and with this embodiment, displayed in the advice display region 60 is a “o” for determinations of good and a “x” for determinations of bad. In FIG. 9, the three items of rhythm, recoil, and DC are determined to be good, and pressing depth is insufficient and determined to be bad, so it is easy to understand that it is possible to improve cardiopulmonary resuscitation by increasing the pressing depth. With this embodiment, for the evaluation information, the determining member that executes the good or bad determination based on the preset reference values and the determination result notification member for notifying the good or bad determination results are both constituted by the personal computer 52. For each item, it is also possible to display numerical values of measurement results or the like in addition to or instead of the good or bad determination results.

Furthermore, in the upper right section of the monitor display, a support display region 62 is provided that displays if the compression position is good or bad and the number of compressions. In the support display region 62, displayed are “∘” for determinations of good and “x” for determinations of bad based on the good or bad determination results of the compression position, and the number of chest compressions from training start until the current time are displayed. Regarding the items determined to be bad based on the good or bad determination results displayed in the advice display region 60 and the support display region 62, it is possible to provide an advice member that notifies a course of action for changing to make them good, and to display or pronounce “Please press deeper,” for example.

Furthermore, at the bottom of the support display region 62, provided is a CCF display region 64. The CCF display region 64 is a region for displaying the CCF calculated with the ratio of the chest compression execution time to the cardiac arrest time of the person receiving life support (elapsed time from confirmation of cardiac arrest) as a percentage, and with this embodiment, in addition to the typical CCF noted above, the effective CCF is also displayed. In the CCF display region 64, in addition to or instead of the display in FIG. 9, it is also possible to display an item calculated with the ratio of the chest compression execution time in relation to the cardiac arrest time as a percentage, where the time when the good or bad determination results are determined to be good is used as the chest compression execution time.

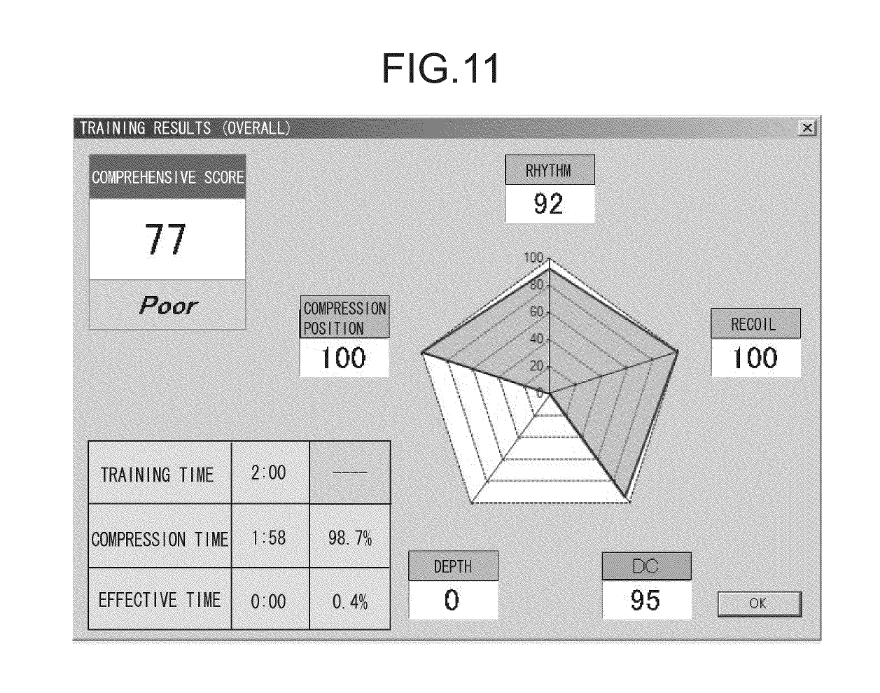

Also, in the lower part of the monitor display, provided is a graph display region 66 on which changes in the pressing depth in relation to time elapse during training are displayed as a graph. Furthermore, above the advice display region 60, provided is a graph enlarged display region 68 that extracts only a specific short time with the graph display region 66 and does enlarged display of that. At the left side of the graph display region 66, provided are a start switch 70 that starts display by selecting using a pointing device such as a mouse or the like, and an evaluation switch 72 that switches to the good or bad determination result screen in FIG. 11 described later by selecting using a pointing device such as a mouse or the like.

Meanwhile, FIG. 11 shows an example of the good or bad determination results displayed on the monitor 54 of the personal computer 52 after completion of training of the cardiopulmonary resuscitation in FIG. 9 (after the end of compression on the pressure sensing part 24). As described above, the good or bad determination results are the respective evaluations of the pressing depth during compression, pressing depth during release, compression time ratio (duty cycle), and number of compression per minute (rhythm) with preset determination values as criteria, and in FIG. 11, there is additionally a fifth item evaluated which is skew of the compression position from the target position, and those evaluation results are displayed.

In more specific terms, the five items noted above are graded on a 100 point scale with the determination values as the criteria, and the score for each item is displayed, and so as to be able to easily grasp the balance of the scores for each item, a pentagonal radar chart that shows the five item score balance is displayed. Furthermore, the average of the five item scores is shown as a comprehensive score, and the good or bad determination results of the comprehensive score are displayed as text below the comprehensive score. Also, the time for which training was performed (training time), the time for which cardiopulmonary resuscitation was actually performed from training start to end (compression time), and the time for which effective cardiopulmonary resuscitation was implemented for which the five items noted above all exceeded the determination value (effective time) are respectively displayed, and the ratio of the compression time and the effective time to the training time are displayed as percentages. With this embodiment, the personal computer 52 is configured to execute a good or bad determination in regard to the evaluation information by using determination values set for the evaluation information as criteria, and the good or bad determination results are displayed on the monitor 54 of the personal computer 52. Thus, the determining member and evaluation result display member are both constituted by the personal computer 52.

With the specific example shown in FIG. 11, as shown with the graph in FIG. 9, since the pressing depth over roughly the entire training time did not reach the determination value of 5 cm, the score for the depth item is 0, and the effective time was very short, so the comprehensive score was low at 77 points, and bad determination results of “poor” was displayed for the good or bad determination. In this way, by quickly giving the person doing training an objective determination of good or bad for the training results, the person doing training is able to have an awareness of the training goal and improvement points, and to efficiently progress with training.

The results in FIG. 11 are an example of not notifying the person doing training of the monitor information of the personal computer 52 (FIG. 9) displayed in real time during implementation of cardiopulmonary resuscitation, but by giving the person doing training that monitor information during the training, it is possible to make improvements during training. Specifically, with FIG. 9, the depth being insufficient is shown as a symbol in the advice display region 60, so the person doing training views the monitor 54 of the personal computer 52 or the assistant communicates the display contents of the monitor 54, and by the advice display information being given to the person doing training as need arises, the person doing training is able to follow that advice display and make improvements such as intentionally making the pressing depth deeper. In this way, by displaying the course of action for changing on the advice display region 60 and the support display region 62 of the monitor 54 of the personal computer 52 as a symbol, the advice member of this embodiment is constituted.

The training results evaluation method described above is merely one example, and it is also possible to use other evaluation methods. In specific terms, with FIG. 11, there is a comprehensive evaluation based on the average points of the scores for each item, but for example, it is also possible to have the comprehensive evaluation be bad when one or a designated number of items were apart from the determination value exceeding an allowed range regardless of the other item scores. Also, for example, it is also possible to have the comprehensive evaluation based on the average of the skew volume (deviation) from the criterion (determination value) for each item.

Also, the display method of the training results is not particularly limited. Specifically, in addition to showing the comprehensive evaluation as points and text as with the embodiment noted above, it is also possible to show the comprehensive evaluation as good or bad using text or symbols (“∘” and “x” for example), or showing an achievement rate (%) of the comprehensive evaluation to the determination value.

With this kind of cardiopulmonary resuscitation support device 10 constituted according to this embodiment, it is possible to respectively detect the compression position on the chest, the number of chest compressions, the number of chest compressions per unit of time (rhythm), the chest pressing depth during compression and during release, and the chest compression time ratio, so it is possible to provide assistance so as to more suitably execute cardiopulmonary resuscitation based on those detection results.

Furthermore, the cardiopulmonary resuscitation support device 10 has the pressure sensing part 24 that detects compressions formed using an elastomer so that it can be deformed flexibly, deforming along the irregularities of the chest surface is easy, and slipping from the chest does not occur easily, so there is a decrease in detection result errors due to having a gap between the pressure sensing part 24 and the chest. In fact, the person doing training has a reduction in the sense of unfamiliarity during compression by going via the pressure sensing part 24, so it is possible to perform training with roughly the same sense as when not using the cardiopulmonary resuscitation support device 10. In addition, there is no occurrence of pain or injury due to contact by the pressure sensing part 24 during compression.

Furthermore, the surface area of the pressure sensing part 24 is the average surface area or greater than the chest compression part on a person's palm, so it is possible to effectively detect changes in electrostatic capacity due to compressions of the chest using the palm, and even if there is a skew in the compression position of the palm within a range that does not stray from the suitable chest compression area, it is possible to effectively detect each parameter of cardiopulmonary resuscitation. In particular, by using the flexible pressure sensing part 24 formed of an elastomer, even if the surface area of the pressure sensing part 24 is made sufficiently large, the pressure sensing part 24 deforms along the surface of the chest, so it is possible to effectively detect changes in electrostatic capacity along a wide range. In fact, the pressure sensing part 24 constituting the capacitance type sensor can easily change the surface area or detection accuracy by changing the size of the dielectric layer 16 and the electrodes 20a and 20b, or the number of electrodes 20a and 20b or the like.

Also, the noise guard electrode 30 connected to the reference voltage terminal (grounding terminal 38) is overlapped on the electrodes 20b via the insulator layer 28, and in a state with the pressure sensing part 24 overlapped on the human body that is the person receiving life support or the chest of the training dummy 50, the noise guard electrode 30 and the insulator layer 28 are arranged between the electrodes 20b and the human body or the chest of the training dummy 50. Therefore, having a capacitor constituted between the electrodes 20b and the human body or training dummy 50 chest is prevented, and it is possible to avoid the occurrence of errors in the detection results due to the electrostatic capacity of that capacitor so as to obtain detection results with good precision.

Also, the sensor main unit 12 that includes the pressure sensing part 24 is connected to be able to be freely attached and detached with the sensor controller 14 which has a power supply device and measurement means. Thus, for example, it is possible to remove the pressure sensing part 24, for which damage, degradation or the like can occur due to repeated compression, from the sensor controller 14 and replace it as needed. Also, by replacing the sensor main unit 12 after use, it is also possible to keep the sensor main unit 12 that contacts the human body clean. It also goes without saying that it is also possible to replace the sensor controller 14 removed from the sensor main unit 12 when there is breakdown or the like of the sensor controller 14.

Above, we gave a detailed description of embodiment of the present invention, but the present invention is not limited to that specific description. For example, the number of electrodes 20a and 20b was shown as an example, and can be changed as appropriate. In particular, by increasing the number of electrodes 20a and 20b, it is possible to realize more detailed detection or detection in a broader range. Also, the electrodes 20a and 20b are not necessarily limited to the structure of intersecting with each other at a plurality of locations, and for example can also have a structure where they intersect at only one location, or the first electrodes and second electrodes can be arranged facing each other in pairs sandwiching the dielectric layer 16 at a plurality of locations, with the facing parts of the first and second electrodes constituting the detection part. The detection part can also not be provided at a plurality of locations with the pressure sensing part 24, and can be provided at only one location of the pressure sensing part 24.

Also, the noise guard electrode 30 and the insulator layer 28 are not essential. Furthermore, the noise guard electrode 30 and the insulator layer 28 can also be arranged overlapping the elastomer sheet 18a side. By so doing, it is possible to prevent the occurrence of errors in the detection results due to a capacitor being constituted between the hand of the person giving life support and the electrodes 20a. Also, the insulator layer arranged between the noise guard electrode 30 and the first and second electrodes 20a and 20b do not absolutely have to be provided specially as with the embodiment noted above, and for example it is possible to use the elastomer sheets 18a and 18b as the insulator layer. Furthermore, by having the noise guard electrode 30 and the insulator layer 28 be separate units from the sensor main unit 12, and having those noise guard electrode 30 and the insulator layer 28 overlapped on the outer surface of the cover 32, it is also possible to arrange the noise guard electrode 30 and the insulator layer 28 between the first and second electrodes 20a and 20b and the human body.

Furthermore, as the measurement value of the ratio of the compression time for pressing the chest and the return time for not pressing the chest, with the embodiment noted above, the value of the ratio of compression time per one cycle [(t₂−t₁)/(t₃−t₁)] was used, but this is not limited to that, and for example it is also possible to use a value such as [(t₂−t₁)/(t₃−t₂)] or the like. Furthermore, as each measurement value, by using the average value of a plurality of times of two times or more, or going via a suitable frequency pass filter, it is possible to remove noise, to stabilize external display results or the like.

Also, with this embodiment, it is not essential to have a constitution whereby the sensor main unit 12 including the pressure sensing part 24 is connected to be freely attachable and detachable with the sensor controller 14. By connecting the sensor main unit 12 so as to be substantially undetachable, unintended separation of the sensor main unit 12 and the sensor controller 14 is avoided, and reliability is improved.

Furthermore, it is possible to equip a wireless transmission device as the wireless transmission member on the sensor controller 14, and to be able to wirelessly receive by the wireless receiving member of the personal computer 52 side the transmission signals of the wirelessly transmitted measurement results. Also, in that case, it is preferable to include a storage battery in the power supply circuit 40. Furthermore, while the sensor controller 14 is equipped with only the function of wirelessly transmitting electrostatic capacity detection signals, with the personal computer 52, it is also possible to constitute a calculation means for performing the calculation process for finding measurement values such as the target compression force, chest pressing depth and the like from the electrostatic capacity detection signals received wirelessly. By so doing, it is possible to make the structural part that is integrally formed with the sensor main unit 12 more compact, whereby handling is even easier.

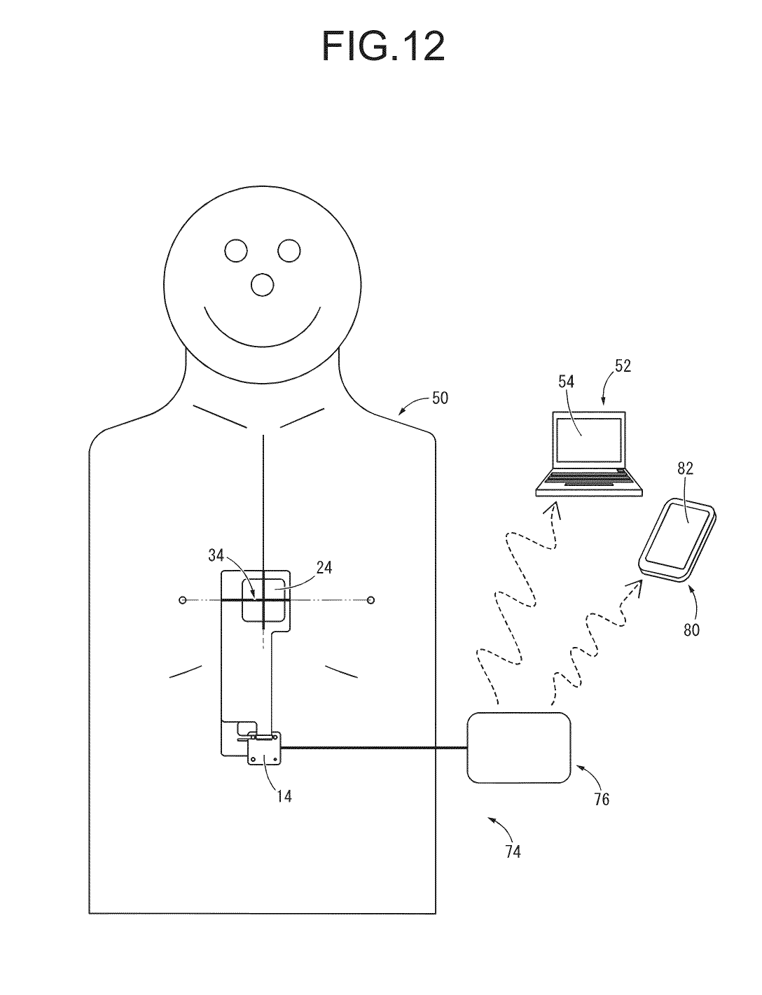

In specific terms, a cardiopulmonary resuscitation support device 74 equipped with a wireless transmission and receiving member is shown as a second embodiment of the present invention in FIG. 12. With the description hereafter, members and parts that are substantially the same as those of the first embodiment are given the same codes in the drawing, and their description will be omitted.

This cardiopulmonary resuscitation support device 74 has a structure whereby the wires 26a and 26b respectively connected to the first and second electrodes 20a and 20b of the pressure sensing part 24 are connected with wires to a wireless transmission device 76 via the sensor controller 14. In other words, the cardiopulmonary resuscitation support device 74 of this embodiment is equipped with a calculation processing member (sensor controller 14) that converts electrostatic capacity detection signals received from the detection parts 22 of the pressure sensing part 24 to wireless transmission signals, and a wireless transmission member (wireless transmission device 76) that wirelessly transmits the generated transmission signals.

Also, with the transmission signals wirelessly transmitted from the wireless transmission device 76, the transmission signals transmitted from the wireless transmission device 76 are configured to be received by a mobile terminal such as the personal computer 52, a tablet 80 or the like equipped with a wireless receiving member. Furthermore, the personal computer 52 or tablet 80 calculate the evaluation information by calculation processing based on the received signals, and display them on the monitors 54 and 82, so as to have a function as a notification member. As the mobile terminal, both the personal computer 52 and the tablet 80 can be used simultaneously, and in that case, a part of the function of the personal computer 52 described with the first embodiment can be distributed to the tablet 80, or it is also possible to have the same processing as that of the personal computer 52 executed in parallel on the tablet 80. Furthermore, it is also possible to provide a separated wireless transmission member to the personal computer 52, and to have the evaluation information processed by the personal computer 52 wirelessly transmitted from the personal computer 52 to the tablet 80 and displayed. On the other hand, it is also possible to use the tablet 80 instead of the personal computer 52, and in this case, the tablet 80 is equipped with the function of the personal computer 52 described with the first embodiment. Furthermore, as the mobile terminal, in addition to the personal computer 52 and the tablet 80 shown as examples, a smart phone or the like can also be used. Furthermore, the wireless receiving member is preferably a mobile terminal with excellent portability, but it can also be a stationary terminal (desktop or the like), for example.

With this kind of cardiopulmonary resuscitation support device 74 constituted according to this embodiment, detection signals of the pressure sensing part 24 are transmitted wirelessly to a terminal such as the personal computer 52, table 80 or the like, wires for connecting the terminal are not necessary, and terminal handling properties improve. In particular, when using while transporting using a stretcher, ambulance, helicopter or the like, by the terminal displaying the evaluation information being connected wirelessly with sensing parts such as the pressure sensing part 24, the sensor controller 14 or the like, it is easy to use without obstructing transport by connecting wiring with the terminal. In fact, there is no falling out of wiring that connects the terminal due to vibration during moving, so reliability is improved.

The calculation processing for finding the evaluation information from the detection signals can be executed by the sensor controller 14, and the evaluation information can be wirelessly transmitted as transmission signals. Also, for effective detection results acquired at a sufficient sampling rate to be transferred smoothly wirelessly by a mobile terminal or the like without a delay that can be physically sensed occurring, it is desirable for the wireless data communication speed to be 50 Mbps or greater. Therefore, it is preferable to use Wifi or the like that is capable of higher speed communication than Bluetooth (registered trademark), for example.

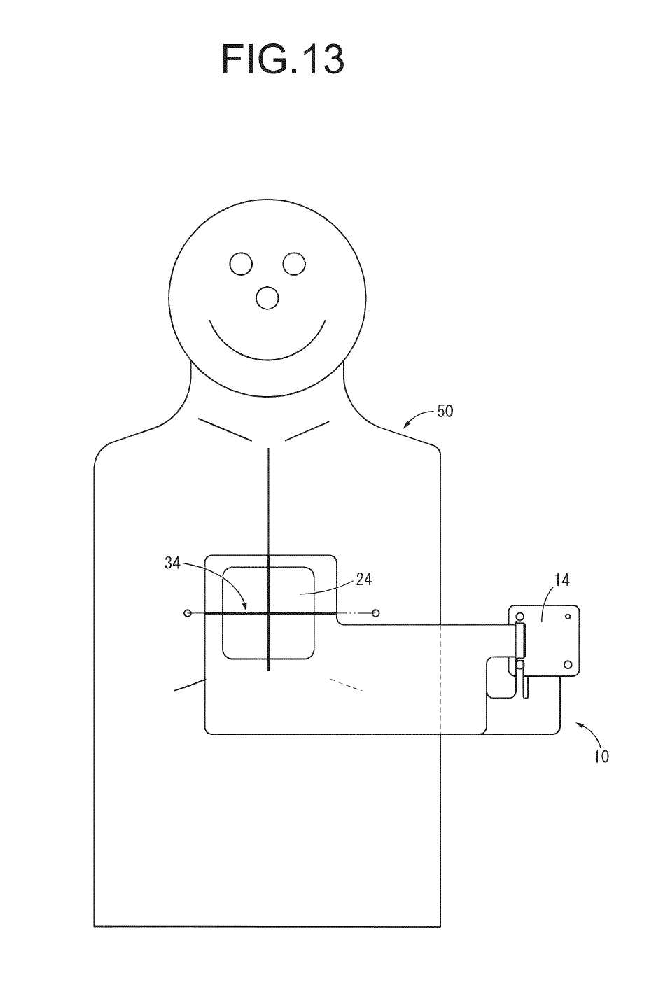

Also, the mounted state of the cardiopulmonary resuscitation support device 10 shown in FIG. 4 on the training dummy 50 is nothing more than an example, and the size of the overall cardiopulmonary resuscitation support device 10, the surface area of the pressure sensing part 24 that covers the chest of the training dummy 50 or the like can be changed as appropriate. Specifically, as shown in FIG. 13, it is also possible to use a cardiopulmonary resuscitation support device 10 of relatively large size equipped with a pressure sensing part 24 with a larger surface area than that of the embodiment noted above, and possible to detect a broader range of compression positions or the like. Also, with the present invention, since the pressure sensing part 24 has a flexible structure, even when a relatively large pressure sensing part 24 is used, the pressure sensing part 24 easily deforms along the surface of the training dummy 50, the irregularities of the hand of the person giving life support and the like. Thus, effective detection is possible, and there is a reduction in sense of unfamiliarity when going through the pressure sensing part 24.

With the embodiment noted above, we described a case of using the cardiopulmonary resuscitation support device 10 of the present invention for cardiopulmonary resuscitation training, but the cardiopulmonary resuscitation support device 10 is not limited to being for training, and can also be used for life support on a person receiving life support. In this case, by notifying the evaluation results during execution of cardiopulmonary resuscitation in real time, it is preferable to prompt corrections to the person giving life support so as to perform more suitable cardiopulmonary resuscitation.

What is claimed is:

1. A cardiopulmonary resuscitation support device for assisting with cardiopulmonary resuscitation using chest compressions, comprising:
a pressure sensing part configured to be overlapped on a chest, the pressure sensing part including a flexible dielectric layer formed of an elastomer, and a flexible first electrode and a flexible second electrode formed of a conductive elastomer and overlapped on respective two surfaces of the dielectric layer;
at least one detection part provided at a facing part of the first electrode and the second electrode in the pressure sensing part so as to detect changes in electrostatic capacity that accompany changes in a facing distance between the first electrode and the second electrode;
a power supply device to apply measurement voltage connected to the first electrode and the second electrode;
a detection member to obtain the electrostatic capacity detected by the detection part, the detection member being connected to the first electrode and the second electrode; and
a processing member to calculate at least one piece of evaluation information from among a number of chest compressions, a number of chest compressions per unit of time, a chest pressing depth during chest compression, a chest pressing depth during chest release, and a ratio of a compression time of pressing the chest and a return time of not pressing the chest, based on a detection value of the electrostatic capacity detected by the detection part obtained by the detection member.

2. The cardiopulmonary resuscitation support device according to claim 1, wherein the at least one detection part comprises a plurality of detection parts provided in the pressure sensing part.

3. The cardiopulmonary resuscitation support device according to claim 2, wherein the first electrode and the second electrode are arranged intersecting at a plurality of locations, and at each location where the first electrode and the second electrode intersect, the first electrode and the second electrode face each other sandwiching the dielectric layer to constitute the detection part.

4. The cardiopulmonary resuscitation support device according to claim 2, wherein the processing member calculates a chest compression position as the evaluation information based on the detection value of the electrostatic capacity detected by the detection parts obtained by the detection member.

5. The cardiopulmonary resuscitation support device according to claim 2, wherein the processing member calculates a ratio of a chest compression time in relation to an elapsed time of cardiac arrest as the evaluation information based on the detection value of the electrostatic capacity detected by the detection parts obtained by the detection member.

6. The cardiopulmonary resuscitation support device according to claim 2, wherein the processing member selects the detection parts for which changes in electrostatic capacity of a threshold value or greater are detected, and based on the detection value of the electrostatic capacity detected by the detection parts selected, the processing member calculates at least one of the chest pressing depth during chest compression and the chest pressing depth during chest release.

7. The cardiopulmonary resuscitation support device according to claim 1, wherein a surface area of the pressure sensing part is an average surface area or greater of a chest compression part on a palm of a person.

8. The cardiopulmonary resuscitation support device according to claim 1, wherein the pressure sensing part is connected to be able to attach and detach freely in relation to the power supply device and the detection member.

9. The cardiopulmonary resuscitation support device according to claim 1, wherein at least one of the first electrode and the second electrode includes a grounded noise guard electrode.

10. The cardiopulmonary resuscitation support device according to claim 1, wherein on at least one of the first electrode and the second electrode, a grounded noise guard electrode is overlapped via an insulator layer.

11. The cardiopulmonary resuscitation support device according to claim 1, further comprising an aligning member that enables the pressure sensing part to be aligned on the chest.

12. The cardiopulmonary resuscitation support device according to claim 1, further comprising a notification member that outputs the evaluation information which is a calculation result of the processing member.

13. The cardiopulmonary resuscitation support device according to claim 12, wherein the notification member comprises a monitor display member that displays a skew of a chest compression position from a suitable position.

14. The cardiopulmonary resuscitation support device according to claim 12, wherein the notification member displays one of the detection value of the electrostatic capacity detected in the pressure sensing part and a value calculated based on the detection value of the electrostatic capacity in map form.

15. The cardiopulmonary resuscitation support device according to claim 1, further comprising:
a wireless transmission member to wirelessly transmit as a transmission signal one of the detection value detected by the detection part and the evaluation information found by the processing member from the detection value;
a wireless receiving member to receive the transmission signal; and
a notification member that notifies the evaluation information based on the signal received by the wireless receiving member.

16. The cardiopulmonary resuscitation support device according to claim 15, wherein the wireless receiving member comprises a mobile terminal.

17. The cardiopulmonary resuscitation support device according to claim 1, further comprising:
a determining member that does good or bad determination in regard to the evaluation information by using a determination value set for the evaluation information as a criterion; and
a determination result notification member that notifies at least one good or bad determination result determined by the determining member.

18. The cardiopulmonary resuscitation support device according to claim 17, further comprising an advice member that, according to the good or bad determination result determined by the determining member, notifies a course of action for changing the determination result to be good when the determination result is bad.

19. The cardiopulmonary resuscitation support device according to claim 17, wherein the at least one good or bad determination result comprises a plurality of good or bad determination results, and a chest compression time for which at least one good or bad determination result determined by the determining member is good based on the evaluation information is calculated as a ratio in relation to an elapsed time of cardiac arrest.

20. The cardiopulmonary resuscitation support device according to claim 19, wherein the chest compression time for which all the good or bad determination results determined by the determining member are good based on the evaluation information is calculated as the ratio in relation to the elapsed time of cardiac arrest.

21. The cardiopulmonary resuscitation support device according to claim 1, further comprising a positioning member that positions the pressure sensing part on the chest.

22. The cardiopulmonary resuscitation support device according to claim 1, wherein the pressure sensing part is used by being mounted on a training dummy.

23. The cardiopulmonary resuscitation support device according to claim 22, further comprising:
a determining member that does good or bad determination in regard to the evaluation information by using a determination value set for the evaluation information as a criterion; and
an evaluation result display member that displays a good or bad determination result determined by the determining member after compression on the pressure sensing part ends.
